(19) United States
(12) Patent Application Publication
(10) Pub. No.: US 2025/0304508 A1
(43) Pub. Date: Oct. 2, 2025

(54) PROCESSES FOR USING REACTIVE LIME AND/OR MAGNESIA-CONTAINING MATERIALS IN CONCRETE BY LOW TEMPERATURE AND LOW-PRESSURE HYDROTHERMAL DENSIFICATION PROCESSES AND RELATED COMPOSITIONS AND APPARATUS

(71) Applicant: CarbonBuilt, Inc., El Segundo, CA (US)

(72) Inventors: Iman MEHDIPOUR, Los Angeles, CA (US); Ho Wai CHEUNG, Redondo Beach, CA (US); Naser POURAKBAR SHARIFI, Irvine, CA (US)

(21) Appl. No.: 19/235,424

(22) Filed: Jun. 11, 2025

Related U.S. Application Data
(63) Continuation of application No. PCT/US2023/085841, filed on Dec. 22, 2023.
(60) Provisional application No. 63/477,366, filed on Dec. 27, 2022.

(51) Int. Cl. C04B 40/02; C04B 14/10; C04B 18/02; C04B 18/08; C04B 28/10; C04B 28/14; C04B 103/22

(52) U.S. Cl. CPC C04B 40/0231; C04B 14/10; C04B 18/027; C04B 18/08; C04B 28/105; C04B 28/14; C04B 40/024; C04B 40/0277; C04B 2103/22

(57) ABSTRACT

Set forth herein are processes and reagents for using concrete mixtures to make concrete in which the concrete mixture includes reactive CaO or reactive MgO and hardens via hydrothermal densification process comprising hydration and carbonation reactions. In hydrothermal densification process water in the form of vapor, liquid, or steam and CO₂ in the form of gaseous or liquid or a combination thereof are enforced in concrete pore space to form hydrated calcium carbonates (HCC) and/or hydrated magnesium carbonates and other hydration products to densify concrete microstructure. Certain processes and reagents are useful for adjusting the initial porosity of a concrete mixture. Certain processes and reagents are useful for regulating the rate of microstructure development of concrete during curing. Certain processes and reagents are useful for adjusting the initial porosity of a concrete mixture and also useful for regulating the rate of microstructure development of concrete during curing. The instant disclosure provides pathways for the utilization of lime/magnesia-containing industrial solid waste that otherwise cannot be generally used for concrete applications.

### CROSS-REFERENCE TO RELATED APPLICATIONS

This application claims priority to, and the benefit of, U.S. Provisional Patent Application No. 63/477,366, filed Dec. 27, 2022, the entire contents of which are herein incorporated by reference in its entirety for all purposes.

### BACKGROUND OF THE INVENTION

Industrial mineral residues that include reactive-lime, which is also known as free-CaO, and/or reactive-magnesia, which is also known as free-MgO, include, but are not limited to, cement kiln dust, lime kiln dust, off-spec limes, sorbent/scrubbing residues, ladle slag, iron slag, coal combustion residues such as fly ashes, ponded ashes, landfilled ashes, biomass ashes, fluidized bed combustion ashes, and circulating fluidized bed ashes.

Reactive-lime, also known as calcium oxide or CaO, expands when exposed to water and forms calcium hydroxide, which is also known as Ca(OH)₂. The high reactive-lime content present in certain alkaline-rich (e.g., Ca- and Mg-rich) industrial mineral residues (e.g., lime, lime kiln dust (LKD), cement kiln dust (CKD), or high reactive-lime coal combustion residues) restricts their incorporation in concrete formulations due to the volumetric instability and potential volumetric expansion and extensive thermal stresses when such industrial mineral residues are hydrated in concrete. The volumetric expansion associated with hydration can be detrimental by causing cracking, and consequently reducing the mechanical properties and durability of concrete.

Hydration of reactive-lime—CaO—can increase the volume of the CaO by 98%, resulting in higher internal pressure and thus causing microcracks in concrete when CaO is used in concrete formation. Reactive-magnesia—also known as MgO-potentially results in a 148% increase in volume when hydrated.

LKD is a byproduct of the manufacturing of lime and generally contains a relatively high percentage of CaO. LKD is dust or particulate matter collected from lime kiln processing equipment. Manufactured lime can be categorized as high-calcium lime or dolomitic lime. LKD varies based on the processes that form it. For example, the amount of calcium may vary. The reactivity of LKD is primarily controlled by lime content (CaO) and fineness (surface area or particle size). LKD with a higher CaO and fineness is expected to be more reactive. More reactive LKD imposes more challenges for use in concrete due to more expansion potential. High calcium lime is primarily composed of CaO while dolomitic lime is composed of CaO and MgO. LKD is formed within CO₂ gases as a by-product of manufacturing lime. LKD chemical compositions may vary for different plants as a function of the type of limestone used, kiln used, fuel used, and also the kiln operating parameters.

CKD is a powder composed principally of micron-sized particles collected from electrostatic precipitators during the high-temperature production of cement clinker. CKD can vary in composition from virtually unaltered kiln feed to over 90% alkali sulfates and chlorides depending on process type, kiln configuration, raw materials, fuels, process characteristics, and points of collection.

Methods of treating CKD and LKD are known and include leaching CKD and/or LKD with water to remove alkalis and contacting the CKD and/or LKD with CO₂-containing gas to form carbonated minerals. Methods of converting CKD and LKD into an insoluble, immobile, and/or less toxic form, i.e., stabilization, are also known. For example, U.S. Pat. No. 1,307,920 discloses mixing kiln dust with water and passing carbon dioxide into the resulting mixture to substantially neutralize the slurry. However, the product of this mixing and reaction with carbon dioxide could not be recycled back into the cement kiln for its use as a kiln feed material unless the alkali levels of the original dust were very low. See also U.S. Pat. Nos. 4,402,891; 4,402,891; 5,792,440; and 6,331,207.

The above citations do not disclose the use of lime-containing materials directly in concrete applications without any pre-treatment or stabilization methods such as pre-hydration and/or pre-carbonation of lime materials before use in concrete. “Directly” refers to using lime-containing materials as-is without any pre-treatment such as carbonation. What is needed are new processes and concrete mixture formulations for using industrial mineral residues that include reactive-lime/magnesia such as lime kiln dust in concrete, without pre-treatment or stabilization to form hydrated calcium carbonates (HCC) and/or hydrated magnesium carbonates along with other hydration products to exploit cementation through solid volume increase and carbonate mineral formation in concrete microstructure when concrete is exposed to hydrothermal processes such as hydration and carbonation reactions.

Set forth herein are solutions to these problems and others known in the field to which this disclosure pertains.

### SUMMARY OF THE INVENTION

Set forth here are proposed hydrothermal densification processes, compositions, and apparatus for treating waste streams (reactive alkaline waste, concrete waste, brine waste materials) and for mineralizing CO₂ while delivering valuable concrete carbonate products.

In one embodiment, set forth herein is a process for making concrete, wherein the process includes: providing a concrete mixture including reactive CaO-containing materials, reactive MgO-containing materials, or a combination thereof; adjusting the porosity, the microstructure, or both the porosity and the microstructure of the concrete mixture; and solidifying the concrete mixture by a hydrothermal densification process by contacting the concrete mixture with a CO₂-containing gas and H₂O.

In one other embodiment, set forth herein is a multistage process for making concrete, including: providing a concrete mixture in a carbonation reactor;
contacting the mixture in a first stage with a composition including CO₂ and water; and contacting the mixture in a second stage with a composition that has a higher volume percent CO₂ than in the first stage.

In yet another embodiment, set forth herein is a multistage process for making concrete, including: providing a concrete mixture in a carbonation reactor; wet carbonating the mixture in a first stage; and dry carbonating the mixture in a second stage.

In another embodiment, set forth herein is a concrete mixture, including: up to 50% by mass reactive CaO, reactive MgO, or gypsum; and at least one member selected from hydrated calcium carbonate, hydrated magnesium carbonate, or a combination thereof.

In some other embodiments, set forth herein is a concrete mixture, including up to 50% by mass reactive CaO, reactive MgO, or gypsum; and at least one member selected from hydrated lime, hydrated magnesia, or a combination thereof.

In other embodiments, set forth herein is an apparatus for a multi-stage carbonation process, including: at least one carbonation chamber; at least one steam generator coupled to the at least one carbonation chamber in an open-loop configuration; and at least CO₂ enrichment system coupled to the at least one carbonation chamber in a closed-loop configuration.

In another embodiment, set forth herein is a process for making concrete, wherein the process includes providing a concrete mixture comprising reactive lime-containing materials (free-CaO), reactive magnesia (free-MgO)-containing materials, or a combination thereof; adjusting the porosity, the microstructure, or both the porosity and the microstructure of the concrete mixture; and making concrete by hardening concrete by a hydrothermal densification reaction in which water in the form of vapor, liquid, or steam and CO₂-containing gas streams are enforced in concrete pores through hydrothermal densification process. The formation of hydrated calcium carbonates (HCC) and hydrated magnesium carbonates (HMC) during hydration and carbonation reactions can provide densification and improve strength of concrete.

In yet another embodiment, set forth herein is concrete formed by a process disclosed herein.

### BRIEF DESCRIPTION OF DRAWINGS

FIG. 1 shows the reactivity of lime kiln dust samples that are suspended in water as a function of time using the water extinction test following the European standard procedure (NF EN 549-2, 2002).

FIG. 2 shows the reactivity of lime kiln dust samples that are suspended in water as a function of time using the water extinction test following the European standard procedure (NF EN 549-2, 2002).

FIG. 3 shows the conversion of CaO to Ca(OH)₂ of LKD samples in the form of particulates after exposure to an air stream at varying relative humidity contents at T=50° C.

FIG. 4 shows the CO₂ uptake of LKD samples in the form of particulates after exposure to a CO₂-containing gas stream at 12 vol. % CO₂ and varying relative humidity contents at T=50° C. This example shows that a CO₂-containing gas stream in combination with water vapor when contacted with LKD particulates, can introduce simultaneous hydration and carbonation of LKD samples.

FIG. 5A shows the effect of reactive lime content on heat of hydration of mortars containing reactive free lime waste materials.

FIG. 5B shows a correlation between reactive lime content and heat of hydration of mortar samples.

FIG. 6 shows the effect of incorporation of lightweight aggregate on integrity and cracking of mortar samples containing reactive lime materials. The cylindrical block on the left was made with lightweight aggregate and the cylindrical block on the right was made without lightweight aggregates.

FIG. 7 shows a correlation between reactive lime content and compressive strength of concrete made with varying free lime contents by mass of total binder.

FIG. 8 shows an effect of multistage hydrothermal curing process conditions by comparing a process that includes wet carbonation followed by dry carbonation with a process that includes dry carbonation followed by wet carbonation.

FIG. 9 shows a correlation between the chemical composition of binders and the expansion-induced cracking of concrete mixtures that include reactive lime waste materials.

FIG. 10A shows the effect of additives electrical resistivity of concrete mixtures made with varying reactive lime contents.

FIG. 10B shows the effect of compressive strength of concrete mixtures made with varying reactive lime contents.

FIG. 11 shows the effect of gypsum additive on electrical resistivity evolution of concrete mixtures containing reactive free limes contents during hydrothermal densification process.

FIG. 12A shows the effect of gypsum addition on controlling hydration kinetics and rate of microstructural development of concrete mixtures containing reactive free lime.

FIG. 12B shows the effect of controlling the rate of microstructural development through additives of concrete mixtures made with varying free lime contents.

FIG. 13 shows a correlation between electrical resistivity and compressive strength evolution of concrete mixtures containing reactive lime during hydrothermal densification process.

FIG. 14 shows a carbonation apparatus in accordance with an embodiment set forth herein and that is useful for a stepwise CO₂ enrichment curing process.

### DETAILED DESCRIPTION OF THE INVENTION

The present disclosure relates to methods for using reactive lime (free-CaO) and/or magnesia (free-MgO) enriched minerals in concrete mixtures wherein densification of such materials is activated by hydration and carbonation reactions under hydrothermal densification process at low temperatures by diffusion of liquid water, water vapor, steam, and CO₂-containing gas phases, or a combination thereof. The solid volume increase and cementation associated with hydration and carbonation reactions of lime/magnesia-enriched materials during the conversion of reactive lime (CaO) to calcium hydroxide (Ca(OH)₂) and calcium carbonate (CaCO₃) compounds and/or conversion of magnesia (MgO) to magnesium hydroxide (Mg(OH)₂) and magnesium carbonate (MgCO₃) compounds are controlled through hydrothermal reaction process and microstructure development. The formation of hydrated calcium carbonates (HCC) and hydrated magnesium carbonates (HMC) during hydration and carbonation reactions can provide densification and improve strength of concrete. This approach creates new pathways for recycling industrial solid wastes such as lime kiln dust, concrete wastes, reactive magnesium-based materials, cement kiln dust, brine waste materials, and coal combustion residues and makes them suitable for use in concrete applications.

The instant disclosure provides pathways for using reactive alkaline-rich materials in concrete as-is. The disclosure herein provides a benefit for cementation due to solid volume increase (expansion) and carbonate mineral formation of these alkaline materials when concrete containing alkaline is exposed to CO₂ gas during hydrothermal process. However, when alkaline materials are pre-carbonated and used as an ingredient in the concrete mixture, there is no benefit of reactivity and solid volume increase or carbonate precipitation when concrete is exposed to CO₂ gas.

By altering the concrete microstructure to control the formation of expansive compounds during hydration and carbonation reactions, beneficial densification in concrete at low temperatures is achieved. This creates pathways for the utilization of reactive lime/magnesia-containing industrial solid waste that otherwise cannot be generally used for concrete applications.

In concrete after forming, CO₂ and moisture transport through the concrete is often the rate-limiting step. In the absence of pressure gradients, CO₂ and moisture transport are dominated by diffusion and permeability. The diffusivity of partially saturated concrete pores is inversely proportional to the microstructural resistance factor. The microstructural resistance to diffusion decreases as the total porosity is increased and as the volume fraction of porosity that is saturated with liquid water is decreased. Detailed herein are at least one or more hydrothermal densification processes that use CO₂-including gas stream and water in the form of liquid, vapor, steam, or a combination thereof, to hydrate, to carbonate, or to hydrate and carbonate, minerals such as alkaline-rich minerals.

Detailed herein are at least one or more hydrothermal densification processes that use CO₂-including gas stream and water in the form of liquid, vapor, steam, or a combination thereof, to convert reactive-lime, reactive-magnesia, or both, to hydrated lime, or hydrated magnesia, or both. This hydration enhances the carbonation reaction of alkaline-rich mineral materials when contacted with CO₂-containing gas streams in a concrete medium. The water present in the CO₂ gas stream and concrete pore structure serves as a catalyst to dissolve and transport CO₂ species and Ca/Mg species in concrete pores. This dissolution results in the precipitation of carbonate minerals and densification process of concrete.

While the disclosure has been described with reference to the specific embodiments thereof, it should be understood by those skilled in the art that various changes may be made, and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

The embodiments, illustratively described herein may suitably be practiced in the absence of any element or elements, limitation or limitations, not specifically disclosed herein. The terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology.

The present disclosure relates to methods using reactive lime, which is also known as reactive-CaO, and/or magnesia (free-MgO) industrial mineral residues in concrete mixtures. The reactive CaO and/or reactive MgO in a concrete mixture are activated by hydration and carbonation reactions. These reactions include hydrothermal densification at low temperatures by the reaction of the reactive CaO and/or reactive MgO with liquid water, water vapor, steam, CO₂-containing gas, or a combination thereof. The amount of solid volume increase associated with these hydration and carbonation reactions during the hydrothermal densification process is caused by the conversion of free-lime (CaO) to calcium hydroxide (Ca(OH)₂) and calcium carbonate (CaCO₃) and/or conversion of magnesia (MgO) to magnesium hydroxide (Mg(OH)₂) and magnesium carbonate (MgCO₃). The hydrothermal densification process, in turn, is thus controlled by the initial porosity and rate of microstructural densification of concrete. This is controlled by rate of water and CO₂-containing gas in pores of concrete through flow rate and concentration that controls rate of dissolution of calcium and/or magnesium species and carbonate species to precipitate carbonate minerals in concrete. This is measured and quantified by CO₂ sensor(s) and gas flow rate sensor(s). To measure CO₂ in concrete, TGA method is used as described in examples. The rate of CO₂% of gas is defined based on CO₂% and flow rate of gas. This is measured and quantified by a RH sensor(s) and flow rate sensor(s) of gas. RH sensor may be embedded in concrete to measure relative humidity and moisture content of concrete. The rate of water introduction is defined based on the moisture content of gas and the relative humidity of gas.

This is because the initial porosity and rate of microstructural densification of a mixture, which is used to make concrete, affects the rate at which the hydration and carbonation reactions during the hydrothermal densification process occur.

Set forth herein are methods of controlling the hydration and carbonation reactions occurring during the hydrothermal densification process in a concrete mixture that includes free-lime or free-magnesia by controlling the initial porosity and rate of microstructural densification of a concrete mixture. The methods herein are useful for making concrete by using industrial solid wastes such as lime kiln dust, concrete wastes, reactive magnesium-based materials, cement kiln dust, brine waste materials, and coal combustion residues, without using known pretreatment or stabilization processes.

Concrete can be produced by either wet-casting or dry-casting. Wet-casting includes a process in which a slurry is poured into a mold until it hardens. Dry-casting includes a process in which components having very low water contents are mechanically compacted/pressed until they are self-supporting. In the absence of separate liquid water or water vapor or steam stream, the densification process of the concrete mixture can be achieved via humidification of CO₂-containing gas stream or without humidification in which water is supplied through water present in concrete pores to progress dissolution and precipitation. However, faster rates and greater extents of densification can be achieved when CO₂-containing gaseous phase is present in combination with liquid water or water vapor. This promotes a dissolution-precipitation mechanism of hydration and carbonation reactions via hydrothermal reactions in the concrete mixture when the mixture includes free-lime and/or free-magnesia minerals.

In one embodiment, the hydrothermal densification process includes, first, conventional processing to produce a porous concrete matrix with interconnected pores. Second, the porous network is infiltrated or diffused with a fluid that consists of liquid water, water vapor, steam and CO₂-containing gaseous phases. Subsequently, a thermodynamically favored, kinetically limited hydrothermal reaction is initiated to dissolve calcium and or magnesium species and CO₂ species in the porous matrix and precipitate hydration and carbonate reaction products that fill the pore space. The reaction product has a larger molar volume than that of the matrix, and this causes the reaction front to move within the pore to fill it. Under optimal processing conditions, the hydrothermal densification process forms a bonding matrix in concrete. In addition, the low processing temperatures minimize the possibility of microcracks or critical failure due to differential thermal expansion-driven stress.

In another embodiment, set forth herein, is a hydrothermal densification process in porous concrete that includes lime and/or magnesia minerals. The process includes (1) the dissolution of the reactants to release Ca and Mg species within the concrete pore structure; (2) the dissolution and diffusion of fluid (CO₂ species, liquid water, and water vapor, steam) within the concrete pore structure and (3) precipitation of hydration compounds (e.g., Ca(OH)₂, Mg(OH)₂, calcium-silicate hydrate (C-S-H), calcium-alumina-silicate hydrate (C-A-S-H)) and carbonate compounds (e.g., CaCO₃, MgCO₃, and silica gel).

In some embodiments, the lime and/or magnesia mineral reactants are industrial mineral residues. In other embodiments, the lime and/or magnesia mineral reactants are industrial solid wastes. In other embodiments, the lime and/or magnesia mineral reactants are concrete waste streams. In other embodiments, the lime and/or magnesia mineral reactants are from desalination brine waste streams. In other embodiments, the lime and/or magnesia mineral reactants comprise LKD. In other embodiments, the lime and/or magnesia mineral reactants comprise virgin lime. These lime and/or magnesia mineral reactants include a core that includes CaO and/or MgO, and around the core are layers of hydration products of calcium hydroxide and magnesium hydroxide as well as layers of carbonate minerals comprising calcium carbonates and magnesium carbonates. These lime and/or magnesia mineral reactants can bond aggregate particles in concrete during the hydrothermal densification process described herein that uses CO₂-containing gas streams.

In summary, the proposed hydrothermal densification process simultaneously treats waste streams (reactive alkaline waste, concrete waste, brine waste materials) and mineralizes CO₂ while delivering valuable concrete carbonate products.

### Definitions

As used herein, the singular terms “a,” “an,” and “the” include plural referents unless the context dictates otherwise. Thus, for example, reference to an object can include multiple objects unless the context clearly dictates otherwise.

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, “carbonated materials” refers to materials made by contacting CO₂ to an alkaline-rich mineral material (e.g., lime or lime kiln dust), an aluminosilicate mineral material (e.g., coal combustion residues), or any combination thereof. Carbonated materials include, but are not limited to, calcite, vaterite, aragonite, magnesite, amorphous calcium carbonate, magnesium carbonates, or a combination thereof. Carbonated materials may further include oxides, hydroxides, carbonates, silicates, aluminates, sulfites, sulfates, chlorides, nitrates, or nitrites of calcium, magnesium or a combination thereof.

As used herein, “alkaline-rich mineral materials” refers to materials that include reactive Ca and/or Mg and which are used in industrial processes such as scrubbers and sorbents. Herein, reactive means capable of reacting with CO₂ and optionally with H₂O. Alkaline-rich mineral materials include, but are not limited to, concrete wastes, reactive magnesium-based materials, desalination brine waste streams, Ca(OH)₂, lime kiln dust, lime, hydrated lime, cement kiln dust, calcium-rich coal combustion residues, slag, steel slag, iron slag, dolomitic lime, carbide lime, off-spec fly ashes, off-spec limes, calcium-rich fly ashes, calcium-poor fly ashes, biomass ashes, ponded ashes, landfilled ashes, bottom ashes, flue gas ashes, biomass ashes, fluidized bed combustion ashes, circulating fluidized bed ashes, sorbent residues, scrubbing residues, mineral sorbent/scrubbing residues comprising anhydrous CaO and/or Ca(OH)₂, and combinations thereof. The alkaline-rich mineral materials may further comprise at least one of oxides, hydroxides, carbonates, silicates, sulfites, sulfates, chlorides, nitrates, or nitrites of calcium and/or magnesium, or any combination thereof. Alkaline-rich mineral materials that have been used in industrial processes are considered industrial solid wastes. Industrial solid wastes include, but are not limited, to lime kiln dust, concrete wastes, reactive magnesium-based materials, cement kiln dust, brine waste materials, and combinations thereof.

As used herein, “aluminosilicate mineral materials” refers to materials that include silica and alumina in the form of amorphous or crystalline or a combination thereof. Aluminosilicate minerals may include coal combustion residues, slag, off-spec fly ashes, biomass ashes, fluidized bed combustion ashes, steel slag, iron slag calcium-poor fly ashes, biomass ashes, fluidized bed combustion ashes, circulating fluidized bed ashes, calcium-rich fly ashes, calcium-poor fly ashes, ponded ashes, landfilled ashes, bottom ashes, flue gas ashes, and combinations thereof.

Herein, a “residue” is an alkaline-rich mineral material or an aluminosilicate mineral material that has been contacted with a CO₂-containing gas stream, for example, as a sorbent or scrubber in flue gas or it can be an aluminosilicate mineral material that has been obtained as solid waste through industrial processes such as coal combustion residues. An alkaline-rich mineral material residue may include hydrated lime, lime kiln dust, off-spec limes, mineral sorbent/scrubbing residues, or a combination thereof. An aluminosilicate residue may include coal combustion residues, slag, off-spec fly ashes, biomass ashes, fluidized bed combustion ashes, circulating fluidized bed ashes, calcium-rich fly ashes, calcium-poor fly ashes, ponded ashes, landfilled ashes, bottom ashes, flue gas ashes, and combinations thereof. A residue may be referred to in the art as a mineral sorbent. A person having ordinary skill in the art can determine a residue from a material that is not a residue. Residues have impurities (e.g., alumina and sulfur, chloride) that can be identified by chemical oxide characterization methods. Further residues have typically less fineness than virgin minerals. Fineness can be determined by particle size distribution measured by sieve analysis or static light scattering. Residue materials are collected from gas cleaning process such as sorbent residues, scrubbing residues, mineral sorbent/scrubbing residues comprising anhydrous CaO and/or Ca(OH)₂.

As used herein, the “mineral carbonation reactor” or “carbonation reactor,” is a reactor used to produce calcium carbonate by exposing, in a confined space, alkaline-rich mineral materials to a CO₂-containing gas stream.

As used herein, the term “flow-through chamber,” refers to a chamber through which gas may be flowed continuously and at ambient pressure.

As used herein, the term “ambient pressure,” refers to atmospheric pressure on planet Earth.

As used herein, the term “gas conditioning apparatus,” refers to a system that is configured to receive a CO₂-containing gas stream (e.g., flue gas) and adjust the temperature, relative humidity, flow rate, pressure, or a combination thereof, of the CO₂-containing gas stream before flowing the CO₂-containing gas stream out of the gas conditioning apparatus and into, for example, a carbonation reactor or recycle loop connected to a carbonation reactor.

As used herein, the term “CO₂-containing gas stream,” refers to a gas stream that includes CO₂. For example, effluent gas from a source that includes carbon dioxide (CO₂) such as an industrial CO₂-containing gas stream, dilute flue gas stream, a concentrated CO₂ gas stream, and biomass-derived CO₂, are non-limiting examples of CO₂-containing gas streams. CO₂-containing gas streams may include atmospherically derived CO₂, direct air capture CO₂, combined heat power derived CO₂, or steam generator derived CO₂. A CO₂-containing gas stream is characterized by a flow rate, relative humidity, temperature, pressure, and CO₂% by volume.

As used herein, the term “a carbonated concrete composite,” refers to a carbonated concrete object (e.g., a building material) made from early-age (e.g., fresh) concrete that is then contacted with a CO₂-containing gas that carbonates the concrete object.

As used herein, the term “concrete mixtures” refers to a mixture that includes reactive lime and/or reactive magnesia containing minerals.

As used herein, the term “carbonatable concrete mixture” means a mixture comprising, consisting essentially of, or consisting of, one or more materials that is capable of reacting with CO₂ to form a carbonate. A material capable of reacting with CO₂ to form a carbonate includes, but is not limited to, one or more alkaline-rich mineral materials as defined above. A material capable of reacting with CO₂ may further comprise at least one of oxides, hydroxides, carbonates, silicates, sulfites, sulfates, chlorides, nitrates, or nitrites of calcium and/or magnesium, or any combination thereof. Carbonates include, but are not limited to, CaCO₃, MgCO₃, and combinations thereof. Carbonates include, but are not limited to, calcium carbonate, calcite, vaterite, aragonite, or any combination thereof. A concrete mixture may include, but is not necessarily limited to, cementitious materials, alkaline rich mineral materials, and aluminosilicate materials. A concrete mixture may include, but is not necessarily limited to, lime kiln dust, cement, fly ash, and natural aggregates.

As used herein, “green concrete” or “fresh concrete” refers to a concrete mixture before it is solidified.

As used herein, the term “hydrothermal densification process” refers to a solidification process that uses porous concrete or a porous concrete medium precursor to concrete. Hydrothermal densification reactions of concrete refer to the densification of concrete by hydration and/or carbonation reactions that include contacting the concrete with water and a CO₂-containing gas stream. In this process, concrete has pores that are partially filled with water and air. The concrete is typically formed by conventional compaction and pressing. Then, the pores in the concrete are exposed to a CO₂-containing gas, liquid water, water vapor, steam, or a combination thereof, to dissolve CO₂ and/or react CO₂ with calcium and/or magnesium in the concrete or precursor thereto. This results in the precipitation of carbonate minerals in the concrete pores. This, in turn, achieves densification through the aforementioned hydration and carbonation reactions. The hydration and carbonation products form in the concrete microstructure and thereby densify the concrete. In this process, the pores in porous concrete are partially filled with water so that CO₂ gas combines with water in the form of liquid, vapor, or steam. Then, the CO₂ and water can diffuse and infiltrate into the pores and react with alkaline species to precipitate carbonate minerals and form hydrated calcium carbonates (HCC) and/or hydrated magnesium carbonates (HMC) in combination with other hydration products that result in cementation and densification.

As used herein, the term “CO₂-steam process” refers to a hydrothermal densification process in which a porous concrete medium containing reactive calcium and/or magnesium are exposed to steam comprising CO₂-containing gas streams. Porous concrete medium is green concrete/fresh concrete.

As used herein, the term “porous concrete medium,” refers to concrete that is not 100% dense. Electrical resistivity of concrete is a way to measure and characterize the porosity of concrete microstructure, for example, before and after carbonation curing. The procedures in ASTM C1876 for measuring electrical resistivity in concrete are used unless stated otherwise. Electrical resistivity is an indirect measure of microstructural porosity. The initial porosity of concrete is controlled by mixture composition and compaction level. The gas and moisture diffusivity can be estimated from the total moisture diffusion coefficient, (i.e., the sum of liquid water and water vapor diffusion coefficients) using Fick's second law of diffusion. The sides of the cylinders (50 mm×25 mm; d×h) can be sealed using a silicone sealant and aluminum tape to ensure 1-D diffusion. For this boundary conditions, Fick's 2nd law can be expressed as follows where mₜ is the mass loss at a given time, m_{∞}(g) is the ultimate mass loss (i.e., at the infinite time; at equilibrium), t (s) is time, and L (m) is half of the sample thickness. Furthermore, electrical resistivity method can be used to assess porosity and rate of microstructure development of concrete.

$$\frac{{m}_{t}}{{m}_{∞}} = 1 - {\sum }_{n = 0}^{n = ∞} \frac{8}{{( 2 n + 1 )}^{2} {π}^{2}} exp ( \frac{- {{D}_{tot} ( 2 n + 1 )}^{2} {π}^{2} t}{4 {L}^{2}} )$$

As used herein, the term “steam,” refers to water as a gas that is at a pressure higher than atmospheric pressure (1 atm). Steam is supersaturated with water as compared to vapor which is saturated with water.

As used herein, the term “green body” refers to a fresh concrete component after casting and before carbonation.

As used herein, the term “rate of carbonation” refers to the rate at which CO₂ is consumed. To quantify the carbonation kinetics, the time-CO₂ uptake profiles are fitted to an equation of the form

$$C ( t ) = C ( {t}_{u} ) ( 1 - exp [ ( - {k}_{carb} t ) / C ( {t}_{u} ) ] )$$

where k_{carb} is the apparent carbonation rate constant and C(tᵤ) is the ultimate CO₂ uptake at the end of carbonation curing duration. For example, carbonation at or above 0.005 per hour means that k_{carb} is a value 0.005 or greater. This would include but is not limited to, k_{carb} of 0.05, or 0.5, or 1, or 2.

As used herein, a “concrete product,” refers to the product resulting from the carbonation, and optionally the hydration, of a concrete component.

As used herein, a “concrete component,” refers to concrete that may be shaped or pressed in a particular form, e.g., an I-beam, a masonry block, or a flat sheet. The fresh (i.e., unreacted) concrete may include portlandite (Ca(OH)₂) and is capable of reacting with CO₂ to form concrete.

As used herein, the term “Aft,” refers to ettringite (C₆AS₃H₃₂, AFt).

As used herein, the term “AFm,” refers to monosulfoaluminate (C₄ASH₁₂, sulfate-AFm, Ms).

As used herein, the “bonding matrix” refers to reaction products (hydration and carbonation products) that bind particles together and results in the hardening or solidification of concrete and/or in strength gain in the concrete.

As used herein, the term “admixture,” unless specified explicitly otherwise, refers to any set retarding admixture, set accelerating admixture, or air-entraining admixture.

As used herein, the term “microstructure development,” refers to the crystallinity, particle size, phase type (e.g., calcite, vaterite, aragonite), and formation of hydration products or carbonate products in a concrete mixture.

As used herein, the terms “reactive lime (free-CaO) and/or magnesia (free-MgO),” refer to CaO and/or MgO in a material that includes materials other than CaO and/or MgO but in which the CaO and/or MgO is able to react with CO₂. For example, pure CaO includes 100% reactive lime. However, if CaO is encased in a passivating layer of CaCO₃, the encased CaO is not able to further react and is not considered reactive CaO or free CaO. If the passivating layer is removed, for example, by grinding, the unreactive CaO can become reactive CaO once the passivating layer is removed so that CO₂ and/or H₂O can react with the exposed and not reactive, or free, CaO. Similarly, if MgO is encased in a passivating layer of MgCO₃, the encased MgO is not able to further react and is not considered reactive MgO or free MgO. If the passivating layer is removed, for example, by grinding, the unreactive MgO can become reactive MgO once the passivating layer is removed so that CO₂ and/or H₂O can react with the exposed and not reactive, or free, MgO.

As used herein, the term “hydrated calcium carbonates (HCC),” refer to CaCO₃—H₂O, Ca(OH)₂, or a combination thereof.

As used herein, the term “hydrated magnesium carbonates (HMC),” refer to MgCO₃—H₂O, Mg(OH)₂, or a combination thereof.

As used herein, the term “carbonate minerals in concrete,” refer to the reaction products of CO₂ with either, or both, of Ca and Mg.

As used herein, the term “dry carbonation,” refer to carbonation of a concrete mixture, or precursor to concrete, using a CO₂-containing gas stream that has less than 50% relative humidity.

As used herein, the term “wet carbonation,” refer to carbonation of a concrete mixture, or precursor to concrete, using a CO₂-containing gas stream that has greater than 50% relative humidity or super saturated. Wet carbonation includes saturated air (50-100% RH) or supersaturated air with steam.

As used herein, the term “open-loop,” refer to a carbonation system that continuously introduces of gas and continuously vents gas into and out of a carbonation chamber.

As used herein, the term “closed-loop,” refer to a carbonation system that does not continuously introduce gas and continuously vent gas into and out of a carbonation chamber. Instead, a closed-loop system traps gas inside. The closed-loop system may include means for circulating gas inside the closed-loop such as but not limited to fans, blowers, and recycle loop.

### Additional Embodiments

In one embodiment, set forth herein is a process for forming concrete, wherein the process includes providing a concrete mixture comprising free-lime-containing materials (free-CaO), free-magnesia (free-MgO)-containing materials, or a combination thereof; adjusting the porosity, the microstructure, or both the porosity and the microstructure of the concrete mixture; and forming concrete by a hydrothermal densification reaction.

In another embodiment, set forth herein is a process for forming concrete, wherein the process includes providing a concrete mixture comprising reactive free-lime-containing materials (free-CaO), free-magnesia (free-MgO)-containing materials, or a combination thereof; adjusting the porosity, the microstructure, or both the porosity and the microstructure of the concrete mixture; and making concrete by hardening concrete by a hydrothermal densification reaction.

In some embodiments, including any of the foregoing, the forming concrete comprises solidifying concrete.

In some embodiments, including any of the foregoing, the making the concrete by hardening the concrete comprises solidifying concrete.

In some embodiments, including any of the foregoing, the hydrothermal densification reaction is a hydration reaction that forms hydration products or a carbonation reaction that forms carbonate products.

In some embodiments, including any of the foregoing, the hydrothermal densification reaction is combined carbonation hydration reaction that forms hydrated calcium carbonates (HCC) and or hydrated magnesium carbonates (HMC) or a combination thereof.

In some embodiments, the hydrothermal reaction process comprises multi-stage reaction process, in which flow rate CO₂-containing flue gas, water vapor, steam, pressure, and/or CO₂% of streams or a combination thereof are adjusted to control rate of hydration and carbonation reaction and resulting microstructure development.

In some embodiments, the hydrothermal process comprises increasing CO₂ partial pressure, CO₂%, CO₂ pressure, and/or flow rate or combination thereof over the course of process.

In some embodiments, the hydrothermal process comprises adjusting concentration, moisture content, flow rate of water, vapor or steam stream or combination thereof over the course of process.

In some embodiments, including any of the foregoing, the process includes adjusting the rate of microstructure development of the concrete mixture.

In some embodiments, including any of the foregoing, the adjusting the porosity, the microstructure, or both the porosity, and the rate of microstructure development of the concrete mixture, comprises:
(a) adjusting compaction extent to set the initial porosity of the concrete mixture;
(b) adding porosity-enhancing admixtures to set the initial porosity of the concrete mixture;
(c) adding porous aggregates to set the initial porosity of the concrete mixture; (d) adding chemical admixtures (e.g., accelerating, retarding or stabilizing admixtures) or additives (e.g., sulfate, gypsum) to set rate of microstructure development of the concrete mixture;
(e) adding brine waste streams to set rate of microstructure development of the concrete mixture;
(f) adjusting transport rate (flow rate and concentration) of CO₂ and water (concentration) in concrete pores during hydrothermal reaction process or
a combination of steps (a), (b), (c), (d), (e) and (f). Process steps (a), (b), and (c), are useful for adjusting the initial porosity of a concrete mixture. Process steps (d) and (e) and (f) are useful for regulating the rate of microstructure development of concrete during curing.

Electrical resistivity and hydration heat measurements are indicative of microstructural development rate.

In some embodiments, including any of the foregoing, the process comprises adding porosity-enhancing admixtures to set the initial porosity of the concrete mixture.

In some embodiments, including any of the foregoing, the process includes providing an amount of initial free-lime and/or free-magnesia extent in the concrete mixture to affect the rate of microstructure development.

In some embodiments, including any of the foregoing, the concrete mixture comprises free lime and/or free magnesia materials ranging from about 0.5% to about 25% by mass.

In some embodiments, including any of the foregoing, the initial porosity of the concrete mixture ranges from about 1% to about 30%.

In some embodiments, including any of the foregoing, the compaction extent ranges from about 1 MPa to about 30 MPa.

Compaction level, unless specified otherwise, is adjusted through dry-cast concrete manufacturing equipment such as block making machines or concrete extrusion machines. For wet-cast concrete or cast in place concrete, the level of compaction is adjusted via concrete vibration machine or mold vibration machine.

In some embodiments, including any of the foregoing, the content of porous aggregates in the concrete mixture ranges from about 1% to about 50% by mass.

In some embodiments, including any of the foregoing, the content of porosity enhancing admixtures in the concrete mixture ranges from about 0.01% to about 5% by mass of total binder materials. In some embodiments, including any of the foregoing, the rate of microstructure development is delayed from about 5 min to about 24 hours by using set-retarding admixtures, stabilizing admixtures, brine waste materials or a combination thereof during the hydrothermal densification reaction.

In some embodiments, including any of the foregoing, the content of set-retarding admixtures, stabilizing admixtures, and brine waste materials in the concrete mixture ranges from about 0.01% to about 5% by mass of total binder materials.

In some embodiments, including any of the foregoing, the content of sulfate additives in the concrete mixture ranges from about 0.01% to about 25% by mass of total binder materials.

In some embodiments, including any of the foregoing, the content of set-accelerating admixtures or brine waste materials or a combination thereof in the concrete mixture ranges from about 0.01% to about 5% by mass of total binder materials.

Depending on ingredients, precursor types, or reactants in the concrete mixture, the inclusion of porosity enhancing admixtures, or of set-retarding admixtures, is either based on the mass of total concrete or based on the mass of total binder materials. Binder materials, in this context, refers to cement, fly ash, calcium hydroxide-based materials, LKD, reactive free-lime/free magnesia containing materials, concrete waste, brine waste materials.

In some embodiments, including any of the foregoing, the amount of hydration products or carbonate products is a function of reaction residence time, reaction temperature, relative humidity of the reaction, gas flow rate, liquid water flow rate, water vapor flow rate, steam flow rate and CO₂ concentration of a contacting gas stream.

In some embodiments, including any of the foregoing, the process occurs in a carbonation reactor.

In some embodiments, including any of the foregoing, the hydrothermal densification reaction occurs at about 25° C. to about 80° C.

In some embodiments, including any of the foregoing, the hydrothermal densification reaction occurs at about 20° C. to about 30° C.

In some embodiments, including any of the foregoing, the hydrothermal densification reaction occurs at less than 80° C.

In some embodiments, including any of the foregoing, the hydrothermal densification reaction has a relative humidity from about 20% to about 99%.

In some embodiments, including any of the foregoing, the hydrothermal densification reaction has a relative humidity from about 10% to about 50%.

In some embodiments, including any of the foregoing, the hydrothermal densification reaction has a gas flow rate from about 0.01 standard cubic feet per minute (scfm) to about 1000 scfm.

In some embodiments, including any of the foregoing, the CO₂ concentration in the gas is from about 5 vol % to about 100 vol %.

In some embodiments, including any of the foregoing, the process occurs in a carbonation reactor.

In some embodiments, including any of the foregoing, the hydrothermal densification process occurs at atmospheric pressure.

In some embodiments, including any of the foregoing, the hydrothermal densification reaction comprises the diffusion of liquid water, water vapor, steam, CO₂-containing gas phases, or a combination thereof, through the concrete mixture to form hydration and carbonate products to harden concrete mixture.

In some embodiments, including any of the foregoing, the hydrothermal densification reaction comprises the diffusion of steam and CO₂-containing gas phases, or a combination thereof, through the concrete mixture to form hydration and carbonate products to harden concrete mixture.

In some embodiments, including any of the foregoing, the hydrothermal densification reaction comprises the diffusion of steam and CO₂-containing gas phases, or a combination thereof, through the concrete mixture at different curing times to control water and CO₂ transport in concrete.

In some embodiments, including any of the foregoing, the hydrothermal densification reaction comprises the diffusion of steam that comprises CO₂-containing gas stream through the concrete mixture to form hydration and carbonate products to harden concrete mixture.

In some embodiments, including any of the foregoing, the CO₂ concentration in the steam stream is from about 5 vol % to about 100 vol % during hydrothermal reaction process.

In some embodiments, including any of the foregoing, the process includes adding set retarding admixtures, gypsum, brine waste and/or stabilizers delays and adjusts the rate of concrete setting.

In some embodiments, including any of the foregoing, the brines can be obtained as waste streams from industrial operations such as desalination or produced water generated from oil and gas extractions.

In some embodiments, including any of the foregoing, the process includes adding set accelerating admixtures, or brine waste to accelerate and enhance concrete setting.

In some embodiments, including any of the foregoing, the process includes incorporating porous aggregates generates additional free space in the concrete.

In some embodiments, including any of the foregoing, the hydration products, carbonation products, or both, bind particles in the concrete mixture and densify the concrete mixture.

In some embodiments, including any of the foregoing, the concrete mixture has a bonding matrix, and the bonding matrix comprises layers of hydration and carbonate products around the surface of reactants selected from CaO particles, MgO particles, or a combination thereof.

In some embodiments, including any of the foregoing, the CaO particles, MgO particles, or a combination thereof comprise calcium hydroxide, magnesium hydroxide, calcium carbonates, and magnesium carbonates, or a combination thereof.

In some embodiments, including any of the foregoing, the bonding matrix further comprises calcium-silicate hydrate (C—S—H), calcium-alumina-silicate hydrate (C-A-S-H), hydrous silica gel compounds, or a combination thereof.

The process of any one of claims 1-50, wherein the rate of microstructural development is controlled by delaying hydration reaction from 5 minutes to about 15 hours when the free lime content in concrete is more than 5% by mass of total binder.

In some embodiments, including any of the foregoing, the concrete mixture comprises carbonate products selected from calcium carbonate, magnesium carbonate, or a combination thereof.

In some embodiments, including any of the foregoing, the calcium carbonate compounds comprise vaterite, aragonite, calcite, or a combination thereof.

In some embodiments, including any of the foregoing, the concrete mixture comprises lime and/or magnesia materials ranging from about 1% to about 40% by mass.

In some embodiments, including any of the foregoing, the hydrothermal densification reaction comprises contacting the concrete mixture with a CO₂-containing gas.

In some embodiments, including any of the foregoing, the hydrothermal densification reaction comprises contacting the concrete mixture with a CO₂-containing steam stream.

In some embodiments, including any of the foregoing, the CO₂-containing gas is a flue gas effluent from an industrial CO₂-containing gas stream, dilute flue gas stream, a concentrated CO₂ gas stream, a commercially available CO₂ source, liquefied CO₂, atmospherically-derived CO₂ (direct air capture), combined heat power derived CO2, steam generator derived CO2, or biomass-derived CO₂.

In some embodiments, including any of the foregoing, the concrete mixture comprises alkaline-rich mineral materials.

In some embodiments, including any of the foregoing, the alkaline-rich mineral materials are selected from the group consisting of cement kiln dust, lime kiln dust, concrete waste, brine waste, magnesium-based materials, dolomitic lime, carbide lime, off-spec limes, sorbent residues, scrubbing residues, steel slag, iron slag, coal combustion residues, ponded ashes, landfilled ashes, bottom ashes, biomass ashes, fluidized bed combustion ashes, circulating fluidized bed ashes, and combinations thereof.

In some embodiments, including any of the foregoing, the alkaline-rich mineral material is cement kiln dust. In some embodiments, including any of the foregoing, the alkaline-rich mineral material is lime kiln dust. In some embodiments, including any of the foregoing, the alkaline-rich mineral material is concrete waste. In some embodiments, including any of the foregoing, the alkaline-rich mineral material is brine waste. In some embodiments, including any of the foregoing, the alkaline-rich mineral material is magnesium-based materials. In some embodiments, including any of the foregoing, the alkaline-rich mineral material is dolomitic lime. In some embodiments, including any of the foregoing, the alkaline-rich mineral material is carbide lime. In some embodiments, including any of the foregoing, the alkaline-rich mineral material is off-spec limes. In some embodiments, including any of the foregoing, the alkaline-rich mineral material is sorbent residues. In some embodiments, including any of the foregoing, the alkaline-rich mineral material is scrubbing residues. In some embodiments, including any of the foregoing, the alkaline-rich mineral material is steel slag. In some embodiments, including any of the foregoing, the alkaline-rich mineral material is iron slag. In some embodiments, including any of the foregoing, the alkaline-rich mineral material is coal combustion residues. In some embodiments, including any of the foregoing, the alkaline-rich mineral material is ponded ashes. In some embodiments, including any of the foregoing, the alkaline-rich mineral material is landfilled ashes. In some embodiments, including any of the foregoing, the alkaline-rich mineral material is bottom ashes. In some embodiments, including any of the foregoing, the alkaline-rich mineral material is biomass ashes. In some embodiments, including any of the foregoing, the alkaline-rich mineral material is fluidized bed combustion ashes. In some embodiments, including any of the foregoing, the alkaline-rich mineral material is circulating fluidized bed ashes

In some embodiments, including any of the foregoing, the concrete mixture comprises an admixture or an additive.

In some embodiments, including any of the foregoing, the admixture or an additive is selected from the group consisting of surfactants, amines, alcohols, glycols, carboxylic acids, triethanolamine (TEA), triisopropanolamine (TIPA), diethylene glycol (DEG), triethylene glycol (TEG), ethanol (EtOH), n-Heptanoic acid (HepAc), ammonium chloride, sodium lauryl sulfate (SLS), N-trimethyl ammonium bromide (CTAB), poly-carboxylate ether (PCE), and diethylisopropanolamine (DEIPA).

In some embodiments, including any of the foregoing, the concrete mixture comprises a blend of aluminosilicate and alkaline-rich mineral materials.

In some embodiments, including any of the foregoing, the concrete mixture comprises a set retarding admixture selected from the group consisting of lignosulphonates, carboxylic acids, phosphonates, sugars, gypsum, brine salts, phosphorus-containing organic acid salts, lignin, borax, tartaric acid, and salts thereof.

In some embodiments, including any of the foregoing, the concrete mixture comprises porosity-enhancing admixtures selected from the group consisting of surfactants, foaming agents, carboxylic acid, sulfonic acid, synthetic detergents, vinsol resins, sulfonated lignin, salts of sulfonated lignin, salts of petroleum acids, salts of proteinaceous material, fatty acids, resinous acids, salts thereof, alkylbenzene sulfonates, and salts of sulfonated hydrocarbons.

In some embodiments, including any of the foregoing, the concrete mixture comprises porous aggregates selected from slag aggregate, expanded clay, bottom ash, pumice, shale, perlite, biochar, cinders, rice husk, slate, and combinations thereof.

In some embodiments, including any of the foregoing, the process includes contacting the concrete mixture with a CO₂-containing flue gas stream having a temperature that ranges from about 20° C. to about 100° C.

In some embodiments, including any of the foregoing, the CO₂ concentration of the CO₂-containing flue gas ranges from 2% to about 100% by volume.

In some embodiments, including any of the foregoing, the flow rate of the CO₂-containing flue gas stream is at least 1 liter per minute.

In some embodiments, including any of the foregoing, the CO₂-containing flue gas stream contacts alkaline-rich mineral materials in a carbonation reactor.

In some embodiments, including any of the foregoing, the reaction time of the hydrothermal densification reaction ranges from 5 minutes to about 72 hours.

In some embodiments, including any of the foregoing, the concrete mixture comprises a mixture of water, reactive Cao containing material, reactive MgO containing materials, hydraulic-carbonating binder system, cement, calcium carbonates, natural pozzolans, aluminosilicate materials, and additives for precast and/or cast-in-place concrete.

In some embodiments, including any of the foregoing, the additives for precast and/or cast-in-place concrete comprise ready mix concrete.

In some embodiments, including any of the foregoing, the process generates calcium silicate and calcium aluminate hydrates, carboaluminate phases as well as AFt and AFm phases.

In some embodiments, including any of the foregoing, the concrete mixture comprises lime and/or magnesia-rich minerals, cement, aggregates, alkaline minerals, aluminosilicate minerals, and water.

In some embodiments, including any of the foregoing, the alkaline-rich mineral residue is collected by contacting a mineral sorbent with a CO₂-containing gas stream (e.g., a flue gas) using scrubbing or sorbent injection (dry or semi-wet) methods, lime kiln dust, and cement kiln dust.

In some embodiments, including any of the foregoing, the mineral sorbent residue is obtained by contacting a mineral sorbent with an atmospheric carbon dioxide source.

In some embodiments, including any of the foregoing, the aluminosilicate mineral is collected from industrial solid wastes including coal combustion residues (e.g., class C fly ash, class F fly ashes), ponded ashes, landfilled ashes, bottom ashes, biomass ashes, fluidized bed combustion ashes, circulating fluidized bed ashes, flue gas ashes, flue gas gypsum, cement kiln dust, and slag (e.g., basic oxygen furnace slag, electric arc furnace slag, ladle slag, or blast furnace slag).

In some embodiments, including any of the foregoing, the carbonate products are selected from calcite, vaterite, aragonite, and combinations thereof.

In some embodiments, including any of the foregoing, the carbonate products comprise at least one of calcite, vaterite, aragonite, magnesite, amorphous calcium carbonates, or a combination thereof.

In some embodiments, including any of the foregoing, the process forms vaterite as spherically shaped particles in concrete.

In some embodiments, including any of the foregoing, the process forms calcite as cubic-shaped particles in concrete.

In some embodiments, including any of the foregoing, the process forms aragonite as needle-shaped particles in concrete.

In some embodiments, including any of the foregoing, the process forms a mixture of calcite, vaterite, aragonite, or a combination thereof.

In some embodiments, including any of the foregoing, the process includes (a) adjusting compaction extent of the concrete mixture during forming concrete to control initial porosity; (b) adding porosity-enhancing admixtures to the mixture to control initial porosity; (c) adding porous aggregates to the mixture to control initial porosity; (d) adding set retarding admixtures to the mixture to control the rate of microstructure development; (e) adding stabilizers to the mixture to control the rate of microstructure development; or a combination of steps (a), (b), (c), (d), and (e). Process steps (a), (b), and (c), are useful for adjusting the initial porosity of a concrete mixture. Process steps (d) and (e) are useful for regulating the rate of microstructure development of concrete during curing.

In some embodiments, including any of the foregoing, the process occurs at less than 80° C. This means that the CO₂ gas is at 80° C. When there is just hydration occurring, the process occurring at less than 80° C. means that the temperature of the chamber in which the process occurs.

In some embodiments, including any of the foregoing, at least one hydrothermal densification reaction comprises the diffusion of liquid water, water vapor, steam, CO₂-containing gas phases, or a combination thereof, through the concrete mixture.

In some embodiments, including any of the foregoing, the free-CaO-containing materials and/or the free-MgO-containing materials are pre-hydrated, prior to incorporating them in the concrete mixture in an aqueous solution in an aqueous-stirring reactor.

In some embodiments, including any of the foregoing, the reactive Cao containing materials and/or free-MgO) containing materials are pre-hydrated by mixing the materials with water to form a slurry before incorporating the materials into the concrete mixture.

In some embodiments, including any of the foregoing, the pre-hydration extent is controlled by a water mixing ratio, water temperature, and mixing speed.

In some embodiments, including any of the foregoing, the reactive Cao containing materials and/or free-MgO) containing materials are pre-hydrated by mixing the materials with aggregates before incorporating the materials into the concrete mixture.

In some embodiments, including any of the foregoing, the pre-hydration extent is controlled by aggregate mixing ratio and aggregate moisture content.

In some embodiments, including any of the foregoing, the liquid-to-solid weight ratio (w/w) ranges from 0.1 to about 10.

In some embodiments, including any of the foregoing, the liquid-to-solid weight ratio (w/w) is 0.1, 0.2, 0.3, 0.4, 0.5, 0.6, 0.7, 0.8, 0.9, 1.0, 2.0, 3.0, 4.0, 5.0, 6.0, 7.0, 8.0, 9.0, or 10.0.

In some embodiments, including any of the foregoing, the liquid-to-solid weight ratio (w/w) is 0.1. In some embodiments, including any of the foregoing, the liquid-to-solid weight ratio (w/w) is 0.2. In some embodiments, including any of the foregoing, the liquid-to-solid weight ratio (w/w) is 0.3. In some embodiments, including any of the foregoing, the liquid-to-solid weight ratio (w/w) is 0.4. In some embodiments, including any of the foregoing, the liquid-to-solid weight ratio (w/w) is 0.5. In some embodiments, including any of the foregoing, the liquid-to-solid weight ratio (w/w) is 0.6. In some embodiments, including any of the foregoing, the liquid-to-solid weight ratio (w/w) is 0.7. In some embodiments, including any of the foregoing, the liquid-to-solid weight ratio (w/w) is 0.8. In some embodiments, including any of the foregoing, the liquid-to-solid weight ratio (w/w) is 0.9. In some embodiments, including any of the foregoing, the liquid-to-solid weight ratio (w/w) is 1.0. In some embodiments, including any of the foregoing, the liquid-to-solid weight ratio (w/w) is 2.0. In some embodiments, including any of the foregoing, the liquid-to-solid weight ratio (w/w) is 3.0. In some embodiments, including any of the foregoing, the liquid-to-solid weight ratio (w/w) is 4.0. In some embodiments, including any of the foregoing, the liquid-to-solid weight ratio (w/w) is 5.0. In some embodiments, including any of the foregoing, the liquid-to-solid weight ratio (w/w) is 6.0. In some embodiments, including any of the foregoing, the liquid-to-solid weight ratio (w/w) is 7.0. In some embodiments, including any of the foregoing, the liquid-to-solid weight ratio (w/w) is 8.0. In some embodiments, including any of the foregoing, the liquid-to-solid weight ratio (w/w) is 9.0. In some embodiments, including any of the foregoing, the liquid-to-solid weight ratio (w/w) is 10.0.

In some embodiments, including any of the foregoing, the concrete mixture comprises carbonate compounds selected from calcium carbonate, magnesium carbonate, or a combination thereof.

In some embodiments, including any of the foregoing, the process includes forming calcium carbonate compounds such as vaterite, aragonite, calcite, or a combination thereof.

In some embodiments, including any of the foregoing, the concrete mixture comprises lime and/or magnesia materials ranging from about 1% to about 40% by mass.

In some embodiments, including any of the foregoing, the at least one hydrothermal densification reaction comprises contacting the concrete mixture with a CO₂-containing gas.

In some embodiments, including any of the foregoing, the CO₂-containing gas is a flue gas effluent from an industrial CO₂-containing gas stream, dilute flue gas stream, a concentrated CO₂ gas stream, a commercially available CO₂ source, liquefied CO₂, atmospherically-derived CO₂ (direct air capture), combined heat power derived CO2, steam generator derived CO2, or biomass-derived CO₂.

In some embodiments, including any of the foregoing, the CO₂-containing gas is a flue gas effluent from an industrial CO₂-containing gas stream. In some embodiments, including any of the foregoing, the CO₂-containing gas is a dilute flue gas stream. In some embodiments, including any of the foregoing, the CO₂-containing gas is a concentrated CO₂ gas stream. In some embodiments, including any of the foregoing, the CO₂-containing gas is a commercially available CO₂ source. In some embodiments, including any of the foregoing, the CO₂-containing gas is liquefied CO₂. In some embodiments, including any of the foregoing, the CO₂-containing gas is atmospherically-derived CO₂ (direct air capture). In some embodiments, including any of the foregoing, the CO₂-containing gas is combined heat power derived CO₂. In some embodiments, including any of the foregoing, the CO₂-containing gas is steam-generator derived CO₂. In some embodiments, including any of the foregoing, the CO₂-containing gas is biomass-derived CO₂.

In some embodiments, including any of the foregoing, the concrete mixture comprises alkaline-rich mineral materials.

In some embodiments, including any of the foregoing, the alkaline-rich mineral materials are selected from the group consisting of cement kiln dust, lime kiln dust, off-spec limes, sorbent residues, scrubbing residues, steel slag, iron slag, coal combustion residues, ponded ashes, landfilled ashes, bottom ashes, biomass ashes, fluidized bed combustion ashes, circulating fluidized bed ashes, and combinations thereof.

In some embodiments, including any of the foregoing, the concrete mixture comprises an admixture or an additive.

In some embodiments, including any of the foregoing, the set-retarding admixture or a set-retarding additive is selected from the group consisting of glycols, carboxylic acids, triethanolamine (TEA), triisopropanolamine (TIPA), diethylene glycol (DEG), triethylene glycol (TEG), ethanol (EtOH), n-Heptanoic acid (HepAc), ammonium chloride, sodium lauryl sulfate (SLS), N-trimethyl ammonium bromide (CTAB), poly-carboxylate ether (PCE), and diethylisopropanolamine (DEIPA).

In some embodiments, including any of the foregoing, the concrete mixture comprises a blend of aluminosilicate and alkaline-rich mineral materials.

In some embodiments, including any of the foregoing, the concrete mixture comprises a set retarding admixture selected from the group consisting of lignosulphonates, carboxylic acids, and their salts, phosphonates, sugars, phosphorus-containing organic acid salts, lignin, borax, tartaric acid, and salts.

In some embodiments, including any of the foregoing, the concrete mixture comprises porosity-enhancing admixtures or air-entraining admixtures selected from the group consisting of surfactants, foaming agents, carboxylic or sulfonic acid, synthetic detergents, vinsol resins, sulfonated lignin, salts of sulfonated lignin, salts of petroleum acids, salts of proteinaceous material, fatty and resinous acids, and salts thereof, alkylbenzene sulfonates, and salts of sulfonated hydrocarbons. Herein, the porosity-enhancing admixtures and air-entraining admixtures are used interchangeably.

In some embodiments, including any of the foregoing, the concrete mixture comprises porous aggregates selected from slag aggregate, expanded clay, bottom ash, pumice, shale, perlite, biochar, cinders, rice husk, slate, and combinations thereof.

In some embodiments, including any of the foregoing, the process includes contacting the concrete mixture with a CO₂-containing flue gas stream ranging from 20° C. to about 100° C.

In some embodiments, including any of the foregoing, the CO₂ concentration of the CO₂-containing flue gas ranges from 2% to about 100% by volume.

In some embodiments, including any of the foregoing, the CO₂ concentration of the CO₂-containing flue gas ranges from 2% to about 10% by volume.

In some embodiments, including any of the foregoing, the CO₂ concentration of the CO₂-containing flue gas ranges from 2% to about 5% by volume.

In some embodiments, including any of the foregoing, the CO₂ concentration of the CO2-containing flue gas ranges from 5% to about 10% by volume.

In some embodiments, including any of the foregoing, the CO₂ concentration of the CO₂-containing flue gas ranges from 5% to about 20% by volume.

In some embodiments, including any of the foregoing, the CO₂ concentration of the CO₂-containing flue gas ranges from 10% to about 20% by volume.

In some embodiments, including any of the foregoing, the flow rate of the CO₂-containing flue gas stream contacting the alkaline-rich mineral materials in the carbonation reactor is at least 1 liter per minute.

In some embodiments, including any of the foregoing, the reaction time of the at least one hydrothermal densification reaction ranges from 5 minutes to about 72 hours depending on the reactive lime or reactive magnesia amount.

In some embodiments, including any of the foregoing, the slurry comprises a mixture of water, reactive Cao containing material, reactive MgO containing materials, hydraulic-carbonating binder system, cement, calcium carbonates, natural pozzolans, aluminosilicate materials, and additives for precast and/or cast-in-place concrete.

In some embodiments, including any of the foregoing, the additives for precast and/or cast-in-place concrete comprise ready-mix concrete.

In some embodiments, including any of the foregoing, the process generates calcium silicate and calcium aluminate hydrates, carboaluminate phases as well as AFt and AFm phases.

In some embodiments, including any of the foregoing, the concrete mixture comprises lime and/or magnesia-rich minerals, cement, aggregates, alkaline minerals, aluminosilicate minerals, and water.

In some embodiments, including any of the foregoing, the alkaline-rich mineral residue is collected by contacting a mineral sorbent with a CO₂-containing gas stream (e.g., a flue gas) using scrubbing or sorbent injection (dry or semi-wet) methods, lime kiln dust, and cement kiln dust.

In some embodiments, including any of the foregoing, the mineral sorbent residue is obtained by contacting a mineral sorbent with an atmospheric carbon dioxide source.

In some embodiments, including any of the foregoing, the aluminosilicate mineral is collected from industrial solid wastes including coal combustion residues (e.g., class C fly ash, class F fly ashes), ponded ashes, landfilled ashes, bottom ashes, biomass ashes, fluidized bed combustion ashes, circulating fluidized bed ashes, flue gas ashes, flue gas gypsum, cement kiln dust, and slag (e.g., basic oxygen furnace slag, electric arc furnace slag, ladle slag, or blast furnace slag).

In some embodiments, including any of the foregoing, the extent of hydration and carbonate compound formation in concrete is controlled by reaction residence time, temperature, relative humidity, gas flow rate, and CO₂ concentration of the contacting gas stream in the carbonation reactor.

In some embodiments, including any of the foregoing, the carbonated phases comprise at least one of calcite, vaterite, aragonite, magnesite, amorphous calcium carbonates, or a combination thereof.

In some embodiments, including any of the foregoing, the process includes forming vaterite as spherically shaped particles in concrete.

In some embodiments, including any of the foregoing, the process includes forming calcite as cubic-shaped particles in concrete.

In some embodiments, including any of the foregoing, the process includes forming aragonite as needle-shaped particles in concrete.

In some embodiments, including any of the foregoing, the process includes forming a mixture of calcite, vaterite, aragonite, and a combination thereof.

In some embodiments, including any of the foregoing, the relative humidity of the CO₂-containing stream ranges from about 5% to about 90%. In some embodiments, including any of the foregoing, the temperature of the contacting CO₂-containing gas stream ranges from 20° C. to about 90° C. In some embodiments, including any of the foregoing, the CO₂ concentration of the CO₂-containing flue gas ranges from 5% to about 100% by volume.

In some embodiments, including any of the foregoing, the reaction residence time of the hydrothermal densification process of concrete comprising lime/magnesia minerals ranges from 5 minutes to about 48 hours. Herein, the reaction residence time is the time that the concrete containing alkaline-rich mineral materials is in contact with the CO₂-containing gas, liquid water, and water vapor or a combination thereof. The residence time starts when the mixture of aggregates, water, and other materials to form concrete, is exposed to the CO₂ gas stream during carbonation curing. The residence time starts when concrete is exposed to the CO₂ gas stream during carbonation curing.

In some embodiments, including any of the foregoing, the flow rate of the CO₂-containing flue gas stream during the hydrothermal densification process of concrete comprising lime/magnesia minerals is at least 1 liter per minute (Standard liters per minute; SLPM).

In some embodiments, including any of the foregoing, the CO₂-containing gas stream is effluent from an industrial CO₂-containing gas stream, dilute flue gas stream, a concentrated CO₂ gas stream, a commercially available CO₂ source, liquefied CO₂, atmospherically-derived CO₂ (direct air capture), or biomass-derived CO₂.

In some embodiments, including any of the foregoing, the pre-hydrating of minerals comprises blending with moist aggregates or mixing with water in a stirring aqueous reactor. In some embodiments, the water for pre-hydration comes from the water inside the aggregates.

In some embodiments, including any of the foregoing, the pre-hydrating of minerals with blending with moist aggregates comprises a controlling moisture content of aggregates, blending ratio of lime/magnesia minerals and aggregates, and storage time before use in concrete.

In some embodiments, including any of the foregoing, the stirring aqueous reactor for pre-hydrating minerals comprises a rotating reactor, which is configured to control material feeding rate, water mixing ratio, hydration temperature, pH of the reaction medium, additive injection rate, reaction resistance time, rotating speed, and fractionation extent.

In some embodiments, including any of the foregoing, the water-to-solid weight ratio (w/w) of the reaction medium in the pre-hydration or pre-carbonation process of lime/magnesia minerals ranges from 0 to about 0.5. This ratio is controlled by liquid water content or water vapor present in the CO₂-containing gas stream in the reactor.

In some embodiments, including any of the foregoing, the stirring aqueous reactor for pre-carbonating minerals comprises a rotating reactor, fluidized bed reactor, which is configured to control material feeding rate, CO₂ gas temperature, gas relative humidity, gas flow rate, gas recirculation rate, pH of the reaction medium, additive injection rate, reaction resistance time, rotating speed, and fractionation extent.

In some embodiments, including any of the foregoing, the hydration and carbonation extents of lime/magnesia minerals during pre-hydration or pre-carbonation processes range from about 0% to 100%.

In some embodiments, including any of the foregoing, the lime/magnesia-rich mineral materials have an average particle size of less than 5 mm. In some embodiments, the mineral materials have an average particle size of at least about 500 μm. In some embodiments, the mineral material has an average particle size of at least about 100 μm. In some embodiments, the mineral material has an average particle size of less than about 500 nm. In some embodiments, the mineral material has an average particle size of less than about 100 nm. In some embodiments, the mineral material has an average particle size of less than about 10 nm. In some embodiments, the mineral material has an average particle size of less than about 1 nm. For particles smaller than 75 μm, particle size is measured using the static light scattering (SLS) method. For particles larger than 75 μm, the particle size is measured using the sieve analysis method.

In some embodiments, including any of the foregoing, the carbonated materials that are formed in the concrete have an average particle size of at least about 1,000 μm.

In some embodiments, including any of the foregoing, the carbonated materials that are formed in the concrete have an average particle size of at least about 1 nm to about 1,000 nm.

In some embodiments, including any of the foregoing, the carbonated material has an average particle size of at least about 500 μm. In some embodiments, including any of the foregoing, the carbonated material has an average particle size of at least about 100 μm. In some embodiments, including any of the foregoing, the carbonated material has an average particle size of less than about 500 nm. In some embodiments, including any of the foregoing, the carbonated material has an average particle size of less than about 100 nm. In some embodiments, including any of the foregoing, the carbonated material has an average particle size of less than about 10 nm. In some embodiments, including any of the foregoing, the carbonated material has an average particle size of less than about 1 nm.

In some embodiments, including any of the foregoing, the pre-hydrated and/or pre-carbonated lime/magnesia-rich minerals are used in concrete in the form of slurry or powder for precast and/or cast-in-place concrete applications.

In some embodiments, including any of the foregoing, the shaping comprises casting, extruding, molding, pressing, or 3D-printing of the cementitious slurry comprising carbonated materials.

In some embodiments, including any of the foregoing, the cementitious slurry comprising hydrated and/or carbonated materials is cast without shaping such as in ready-mix concrete applications.

In some embodiments, set forth herein is a process for making concrete, wherein the process includes: providing a concrete mixture including reactive CaO-containing materials, reactive MgO-containing materials, or a combination thereof; adjusting the porosity, the microstructure, or both the porosity and the microstructure of the concrete mixture; and solidifying the concrete mixture by a hydrothermal densification process by contacting the concrete mixture with a CO₂-containing gas and H₂O.

In some embodiments, set forth herein is a process for making concrete, wherein the process includes: providing a concrete mixture including reactive CaO-containing materials, reactive MgO-containing materials, or a combination thereof; adjusting the porosity, the microstructure, or both the porosity and the microstructure of the concrete mixture; and solidifying the concrete mixture by a hydrothermal densification process in a single stage or in a multistage process by contacting the concrete mixture with a CO₂-containing gas and H₂O.

In some embodiments, including any of the foregoing, the solidifying is performed under wet, saturation or supersaturation condition.

In some embodiments, including any of the foregoing, the hydrothermal densification process is a single stage process in which the flow rate, relative humidity, CO₂ concentration, total pressure, partial pressure, or a combination thereof, are held constant during the hydrothermal densification process.

In some embodiments, including any of the foregoing, the hydrothermal densification process is a multi-stage process in which the flow rate, relative humidity, CO₂ concentration, total pressure, partial pressure, or a combination thereof, are changed during the hydrothermal densification process.

In some embodiments, including any of the foregoing, the hydrothermal densification process is a multi-stage process in which the CO₂ concentration, pressure, or a combination thereof, is increased after the first stage of the multi-stage process.

In some embodiments, including any of the foregoing, the hydrothermal densification process is a multi-stage process in which the H₂O amount is decreased after the first stage of the multi-stage process.

In some embodiments, including any of the foregoing, the hydrothermal densification process is a multi-stage process in which the H₂O is changed after the first stage of the multi-stage process from steam to liquid, from vapor to liquid, from liquid to steam, from liquid to vapor, or a combination thereof.

In some embodiments, including any of the foregoing, the H₂O is liquid water, water vapor, or steam.

In some embodiments, including any of the foregoing, the H₂O is liquid water.

In some embodiments, including any of the foregoing, the H₂O is water vapor.

In some embodiments, including any of the foregoing, the H₂O is steam.

In some embodiments, including any of the foregoing, the process includes forming hydrated calcium carbonates, hydrated magnesium carbonates, or a combination thereof, in the concrete mixture.

In some embodiments, including any of the foregoing, the process includes forming hydrated calcium carbonates, hydrated magnesium carbonates, or a combination thereof, in the porous space of the concrete.

In some embodiments, including any of the foregoing, the process includes diffusing a CO₂-containing gas and water vapor streams through porous space in the concrete.

In some embodiments, including any of the foregoing, wherein the process includes simultaneously diffusing a CO₂-containing gas and liquid water through porous space in the concrete.

In some embodiments, including any of the foregoing, wherein the process includes simultaneously diffusing a CO₂-containing gas and water vapor through porous space in the concrete.

In some embodiments, including any of the foregoing, wherein the process includes changing the form of water at different stages of the multistage process, wherein the form of water is selected from liquid, vapor or steam.

In some embodiments, including any of the foregoing, the concrete mixture includes up to 50% by mass reactive lime and reactive magnesium.

In some embodiments, including any of the foregoing, the concrete mixture includes up to 50% by mass of a combination of reactive lime, reactive magnesium, and sulfate.

In some embodiments, including any of the foregoing, the sulfate is selected from gypsum.

In some embodiments, including any of the foregoing, the process includes adjusting the rate of microstructure development of the concrete mixture.

In some embodiments, including any of the foregoing, wherein the process includes modulating the porosity, the microstructure, the rate of microstructure development, or a combination thereof, in the concrete mixture by: adjusting compaction extent to set the initial porosity of the concrete mixture; adding porosity-enhancing admixtures to the concrete mixture to set the initial porosity of the concrete mixture; adding porous aggregates to set the initial porosity of the concrete mixture; adding additives and admixtures to set the rate of microstructure development of the concrete mixture; or a combination of steps (a), (b), (c), and (d).

In some embodiments, including any of the foregoing, wherein the process includes adding porosity-enhancing admixtures to set the initial porosity of the concrete mixture.

In some embodiments, including any of the foregoing, wherein the process includes providing an amount of reactive CaO or reactive MgO to the concrete mixture to set the initial porosity and the rate of microstructure development of concrete mixture.

In some embodiments, including any of the foregoing, wherein the process includes providing 0.5% to 25% by mass of CaO, reactive MgO, or a combination thereof, total binder of concrete.

In some embodiments, including any of the foregoing, the concrete mixture includes about 0.5% to about 25% by mass reactive CaO, reactive MgO, or a combination thereof.

In some embodiments, including any of the foregoing, the concrete mixture includes 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, or 25%, by mass reactive CaO, reactive MgO, or a combination thereof.

In some embodiments, including any of the foregoing, the rate of microstructure development of the concrete mixture is such that the induction period of hydration is extended from 5 minutes to 10 hours.

In some embodiments, including any of the foregoing, the initial porosity of the concrete mixture ranges from about 1% to about 30% by volume.

In some embodiments, including any of the foregoing, the initial porosity of the concrete mixture ranges from about 5% to about 20% by volume.

In some embodiments, including any of the foregoing, wherein the process includes compacting the concrete mixture at about 1 MPa to about 30 MPa of pressure.

In some embodiments, including any of the foregoing, the concrete mixture includes about 1% to about 50% by mass porous aggregates relative to the total amount of solid materials in the concrete mixture.

In some embodiments, including any of the foregoing, the concrete mixture includes about 0.01% to about 5% by mass porosity enhancing admixtures.

In some embodiments, including any of the foregoing, the concrete mixture has a rate of microstructure development that is delayed from about 5 min to about 24 hours by using set-retarding admixtures, stabilizing admixtures or a combination thereof during the hydrothermal densification process.

In some embodiments, including any of the foregoing, the concrete mixture includes about 0.01% to about 5% by mass set-retarding admixtures, stabilizing admixtures, brine waste material, and sulfate additives.

In some embodiments, including any of the foregoing, the brine waste material includes calcium, magnesium, sulfate, chloride or combination thereof.

In some embodiments, including any of the foregoing, the process occurs in a carbonation reactor.

In some embodiments, including any of the foregoing, the hydrothermal densification process occurs at about 25° C. to about 80° C.

In some embodiments, including any of the foregoing, the hydrothermal densification process occurs at about 20° C. to about 30° C.

In some embodiments, including any of the foregoing, the hydrothermal densification process occurs at about 20° C. to about 40° C.

In some embodiments, including any of the foregoing, the hydrothermal densification process occurs at about 20° C. to about 50° C.

In some embodiments, including any of the foregoing, the hydrothermal densification process occurs at about 20° C. to about 60° C.

In some embodiments, including any of the foregoing, the hydrothermal densification process occurs at about 20° C. to about 70° C.

In some embodiments, including any of the foregoing, the hydrothermal densification process occurs at about 20° C. to about 80° C.

In some embodiments, including any of the foregoing, the hydrothermal densification process occurs at about 20° C. to about 25° C.

In some embodiments, including any of the foregoing, the hydrothermal densification process occurs at about 30° C. to about 40° C.

In some embodiments, including any of the foregoing, the hydrothermal densification process occurs at about 30° C. to about 50° C.

In some embodiments, including any of the foregoing, the hydrothermal densification process occurs at about 30° C. to about 60° C.

In some embodiments, including any of the foregoing, the hydrothermal densification process occurs at about 30° C. to about 70° C.

In some embodiments, including any of the foregoing, the hydrothermal densification process occurs at about 30° C. to about 80° C.

In some embodiments, including any of the foregoing, the hydrothermal densification process occurs at about 40° C. to about 50° C.

In some embodiments, including any of the foregoing, the hydrothermal densification process occurs at about 40° C. to about 60° C.

In some embodiments, including any of the foregoing, the hydrothermal densification process occurs at about 40° C. to about 70° C.

In some embodiments, including any of the foregoing, the hydrothermal densification process occurs at about 40° C. to about 80° C.

In some embodiments, including any of the foregoing, the hydrothermal densification process occurs at about 50° C. to about 60° C.

In some embodiments, including any of the foregoing, the hydrothermal densification process occurs at about 50° C. to about 70° C.

In some embodiments, including any of the foregoing, the hydrothermal densification process occurs at about 50° C. to about 80° C.

In some embodiments, including any of the foregoing, the hydrothermal densification process occurs at about 60° C. to about 70° C.

In some embodiments, including any of the foregoing, the hydrothermal densification process occurs at about 60° C. to about 80° C.

In some embodiments, including any of the foregoing, the hydrothermal densification process occurs at about 70° C. to about 80° C.

In some embodiments, including any of the foregoing, the hydrothermal densification process occurs at less than 80° C.

In some embodiments, including any of the foregoing, the hydrothermal densification process has a relative humidity from about 20% to about 99%.

In some embodiments, including any of the foregoing, the hydrothermal densification process includes contacting the concrete mixture with water in the form of liquid, vapor, steam, combination thereof.

In some embodiments, including any of the foregoing, the hydrothermal densification process includes contacting the concrete mixture with a CO₂-containing gas that has a relative humidity from about 10% to about 50%.

In some embodiments, including any of the foregoing, the hydrothermal densification process includes contacting the concrete mixture with a CO₂-containing gas that has a gas flow rate of at least 1 L/min.

In some embodiments, including any of the foregoing, the hydrothermal densification process includes contacting the concrete mixture with a CO₂-containing gas that has a gas flow rate from about 0.01 standard cubic feet per minute (scfm) to about 1000 scfm.

In some embodiments, including any of the foregoing, the CO₂ concentration in the CO₂-containing gas is about 2% by volume to about 100% by volume.

In some embodiments, including any of the foregoing, the process occurs in a carbonation reactor.

In some embodiments, including any of the foregoing, the hydrothermal densification process occurs at atmospheric pressure.

In some embodiments, including any of the foregoing, wherein the process includes adjusting the rate of concrete setting by adding set retarding admixtures and/or stabilizers.

In some embodiments, including any of the foregoing, wherein the process includes delaying the rate of concrete setting by adding set retarding admixtures and/or stabilizers.

In some embodiments, including any of the foregoing, wherein the process includes generating additional free space in the concrete by incorporating porous aggregates generates.

In some embodiments, including any of the foregoing, the concrete mixture has a bonding matrix, and the bonding matrix includes layers of hydration and carbonate products around the surface of reactants selected from CaO particles, MgO particles, or a combination thereof.

In some embodiments, including any of the foregoing, the CaO particles, MgO particles, or a combination thereof include calcium hydroxide, magnesium hydroxide, calcium carbonates, and magnesium carbonates, or a combination thereof.

In some embodiments, including any of the foregoing, the bonding matrix further includes calcium-silicate hydrate (C—S—H), calcium-alumina-silicate hydrate (C-A-S-H), hydrous silica gel compounds, or a combination thereof.

In some embodiments, including any of the foregoing, the rate of microstructural development is controlled by delaying hydration reaction from 5 min to about 24 hours when the free lime content in concrete is more than 5% by mass of total binder.

In some embodiments, including any of the foregoing, the concrete mixture includes carbonate products selected from calcium carbonate, magnesium carbonate, or a combination thereof.

In some embodiments, including any of the foregoing, the calcium carbonate compounds include vaterite, aragonite, calcite, or a combination thereof.

In some embodiments, including any of the foregoing, the concrete mixture includes lime and/or magnesia materials ranging from about 1% to about 40% by mass.

In some embodiments, including any of the foregoing, the CO₂-containing gas is effluent gas from a source that includes carbon dioxide (CO₂).

In some embodiments, including any of the foregoing, the CO₂-containing gas is an industrial CO₂-containing gas stream, dilute flue gas stream, a concentrated CO₂ gas stream, or biomass-derived CO₂.

In some embodiments, including any of the foregoing, the CO₂-containing gas is atmospherically derived CO₂ or direct air capture CO₂.

In some embodiments, including any of the foregoing, the CO₂-containing gas is combined heat power derived CO₂ or steam generator derived CO₂.

In some embodiments, including any of the foregoing, the concrete mixture includes alkaline-rich mineral materials.

In some embodiments, including any of the foregoing, the alkaline-rich mineral materials are selected from the group consisting of concrete wastes, reactive magnesium-based materials, desalination brine waste streams, Ca(OH)₂, lime kiln dust, lime, hydrated lime, cement kiln dust, calcium-rich coal combustion residues, slag, steel slag, iron slag, dolomitic lime, carbide lime, off-spec fly ashes, off-spec limes, calcium-rich fly ashes, calcium-poor fly ashes, biomass ashes, ponded ashes, landfilled ashes, bottom ashes, flue gas ashes, biomass ashes, fluidized bed combustion ashes, circulating fluidized bed ashes, sorbent residues, scrubbing residues, mineral sorbent/scrubbing residues including anhydrous CaO and/or Ca(OH)₂, and combinations thereof.

In some embodiments, including any of the foregoing, the concrete mixture includes an admixture or an additive.

In some embodiments, including any of the foregoing, the admixture or an additive is selected from the group consisting of surfactants, amines, alcohols, glycols, carboxylic acids, triethanolamine (TEA), triisopropanolamine (TIPA), diethylene glycol (DEG), triethylene glycol (TEG), ethanol (EtOH), n-Heptanoic acid (HepAc), ammonium chloride, sodium lauryl sulfate (SLS), N-trimethyl ammonium bromide (CTAB), poly-carboxylate ether (PCE), and diethylisopropanolamine (DEIPA).

In some embodiments, including any of the foregoing, the concrete mixture includes a blend of aluminosilicate and alkaline-rich mineral materials.

In some embodiments, including any of the foregoing, the concrete mixture includes a set retarding admixture selected from the group consisting of lignosulphonates, carboxylic acids, phosphonates, sugars, phosphorus-containing organic acid salts, lignin, borax, tartaric acid, and salts thereof.

In some embodiments, including any of the foregoing, the concrete mixture includes porosity-enhancing admixtures selected from the group consisting of surfactants, foaming agents, carboxylic acid, sulfonic acid, synthetic detergents, vinsol resins, sulfonated lignin, salts of sulfonated lignin, salts of petroleum acids, salts of proteinaceous material, fatty acids, resinous acids, salts thereof, alkylbenzene sulfonates, and salts of sulfonated hydrocarbons.

In some embodiments, including any of the foregoing, the concrete mixture includes porous aggregates selected from slag aggregate, expanded clay, bottom ash, pumice, shale, perlite, biochar, cinders, rice husk, slate, and combinations thereof.

In some embodiments, including any of the foregoing, wherein the process includes contacting the concrete mixture with a CO₂-containing flue gas stream having a temperature that ranges from about 20° C. to about 100° C.

In some embodiments, including any of the foregoing, wherein the process includes contacting the concrete mixture with a CO₂-containing flue gas stream having a temperature that ranges from about 30° C. to about 80° C.

In some embodiments, including any of the foregoing, the reaction time of the hydrothermal densification process ranges from 5 minutes to about 72 hours depending on the reactive lime or reactive magnesia content. If the total reactive material content is less than 0.1% by mass of total binder, the duration of hydrothermal process is less than 5 min. If total reactive material (reactive lime and reactive magnesia) content is between 0.1% and 10% by mass of total binder, the duration of hydrothermal process ranges from 1 hour to 24 hours. If total reactive material content is between 10% and 50% by mass of total binder, the duration of hydrothermal process ranges from 24 hours to 72 hours.

In some embodiments, including any of the foregoing, the concrete mixture includes a mixture of water, reactive CaO, reactive MgO, cement, calcium carbonates, natural pozzolans, aluminosilicate materials, and additives for precast and/or cast-in-place concrete.

In some embodiments, including any of the foregoing, the natural pozzolans are selected from pumice, shale, metakaolin, or combinations thereof.

In some embodiments, including any of the foregoing, the additives for precast and/or cast-in-place concrete include ready mix concrete.

In some embodiments, including any of the foregoing, the process generates calcium silicate and calcium aluminate hydrates, carboaluminate phases as well as AFt and AFm phases.

In some embodiments, including any of the foregoing, the concrete mixture includes lime and/or magnesia-rich minerals, cement, aggregates, alkaline minerals, aluminosilicate minerals, and water.

In some embodiments, including any of the foregoing, the alkaline-rich mineral residue are collected by contacting a mineral sorbent with a CO₂-containing gas stream (e.g., a flue gas) using scrubbing or sorbent injection (dry or semi-wet) methods, lime kiln dust, and cement kiln dust.

In some embodiments, including any of the foregoing, the mineral sorbent residue is obtained by contacting a mineral sorbent with an atmospheric carbon dioxide source.

In some embodiments, including any of the foregoing, the aluminosilicate mineral is collected from industrial solid wastes including coal combustion residues (e.g., class C fly ash, class F fly ashes), ponded ashes, landfilled ashes, bottom ashes, biomass ashes, fluidized bed combustion ashes, circulating fluidized bed ashes, flue gas ashes, flue gas gypsum, cement kiln dust, and slag (e.g., basic oxygen furnace slag, electric arc furnace slag, ladle slag, or blast furnace slag).

In some embodiments, including any of the foregoing, the process produces carbonate products selected from calcite, vaterite, aragonite, and combinations thereof.

In some embodiments, including any of the foregoing, the process produces carbonate products that include at least one of calcite, vaterite, aragonite, magnesite, amorphous calcium carbonates, or a combination thereof.

In some embodiments, including any of the foregoing, wherein the process includes measuring electrical resistivity of the concrete mixture.

In some embodiments, including any of the foregoing, wherein the process includes determining hydration and, or, initiation of expansive induced cracking of the concrete mixture, based on an electrical resistivity measurement.

In some embodiments, including any of the foregoing, wherein the process includes measuring compressive strength of the concrete mixture.

In some embodiments, including any of the foregoing, wherein the process includes determining hydration and, or, initiation of expansive induced cracking of the concrete mixture, based on a compressive strength measurement.

In some embodiments, including any of the foregoing, the mixture includes reactive lime-containing materials, reactive magnesia-containing materials, or a combination thereof.

In some embodiments, including any of the foregoing, the mixture includes reactive CaO, reactive MgO, or a combination thereof.

In some embodiments, including any of the foregoing, wherein the process includes adjusting the porosity, the microstructure, or both the porosity and the microstructure of the concrete mixture.

In some embodiments, including any of the foregoing, the process produces hydrated calcium carbonates, hydrated magnesium carbonates or a combination thereof.

In some embodiments, including any of the foregoing, the concrete mixture includes porous aggregates.

In some embodiments, including any of the foregoing, the concrete mixture up to 25% by mass includes porous aggregates.

In some embodiments, including any of the foregoing, the concrete mixture includes clay aggregates.

In some embodiments, including any of the foregoing, the concrete mixture includes porosity-creating admixtures.

In some embodiments, including any of the foregoing, the concrete mixture includes air—In some embodiments, including any of the foregoing, the concrete mixture includes LKD, cement, fly ash, and natural aggregates.

In some embodiments, including any of the foregoing, the concrete mixture includes reactive lime waste, fly ash, and natural aggregates.

In some embodiments, including any of the foregoing, the concrete mixture includes set retarding and stabilizing admixtures selected from the group consisting of lignosulphonates, carboxylic, or phosphorus-containing organic acid-based admixtures.

In some embodiments, including any of the foregoing, the concrete mixture includes porous lightweight aggregate.

In some embodiments, including any of the foregoing, the concrete mixture includes about 5% to 50% by mass porous lightweight aggregate.

In some embodiments, including any of the foregoing, wherein the concrete mixture includes up to 50% by mass reactive CaO and [SO₃].

In some embodiments, including any of the foregoing, wherein the concrete mixture includes up to 50% by mass reactive CaO and gypsum.

In some embodiments, including any of the foregoing, wherein the concrete mixture includes about 22% by mass porous lightweight aggregate.

In some embodiments, including any of the foregoing, wherein the concrete mixture has a porosity of sample between 3 and 30% by volume before the hydrothermal densification process.

In some embodiments, including any of the foregoing, wherein the process increases the strength of the concrete mixture by 25%.

In some embodiments, including any of the foregoing, wherein the process increases the initial porosity by about 9%.

In some embodiments, including any of the foregoing, wherein the process increase the density of the concrete mixture by 8%.

In some embodiments, including any of the foregoing, wherein the process occurs in a carbonation reactor.

In some embodiments, set forth herein is a multistage process for making concrete, including: providing a concrete mixture in a carbonation reactor; contacting the mixture in a first stage with a composition including CO₂ and water; and contacting the mixture in a second stage with a composition that has a higher volume percent CO₂ than in the first stage.

In some embodiments, set forth herein is a multistage process for making concrete, including: providing a concrete mixture in a carbonation reactor; wet carbonating the mixture in a first stage; and dry carbonating the mixture in a second stage.

In some embodiments, including any of the foregoing, the dry carbonating further includes using a higher volume percent CO₂ than in the first stage.

In some embodiments, including any of the foregoing, the first stage is an open loop stage.

In some embodiments, including any of the foregoing, the second stage is a closed loop stage.

In some embodiments, including any of the foregoing, the process includes circulating the CO₂-containing gas in the closed loop stage.

In some embodiments, including any of the foregoing, the CO₂ utilization efficiency is higher than in a single stage process.

In some embodiments, including any of the foregoing, the flow rate, relative humidity, CO₂ concentration, total pressure, partial pressure, or a combination thereof, are held constant during the first stage.

In some embodiments, including any of the foregoing, the flow rate is held constant during the first stage.

In some embodiments, including any of the foregoing, the relative humidity is held constant during the first stage.

In some embodiments, including any of the foregoing, the CO₂ concentration is held constant during the first stage.

In some embodiments, including any of the foregoing, the total pressure is held constant during the first stage.

In some embodiments, including any of the foregoing, the partial pressure is held constant during the first stage.

In some embodiments, including any of the foregoing, the flow rate, relative humidity, CO₂ concentration, total pressure, partial pressure, or a combination thereof, are changed during the first stage or second stage.

In some embodiments, including any of the foregoing, the flow rate, relative humidity, CO₂ concentration, total pressure, partial pressure, or a combination thereof, are held constant during the first stage.

In some embodiments, including any of the foregoing, the flow rate is changed during the first stage or second stage.

In some embodiments, including any of the foregoing, the relative humidity is changed during the first stage or second stage.

In some embodiments, including any of the foregoing, the CO₂ concentration is changed during the first stage or second stage.

In some embodiments, including any of the foregoing, the total pressure is changed during the first stage or second stage.

In some embodiments, including any of the foregoing, the partial pressure is changed during the first stage or second stage.

In some embodiments, including any of the foregoing, the CO₂ concentration, pressure, or a combination thereof, is increased after the first stage.

In some embodiments, including any of the foregoing, the H₂O amount is decreased after the first stage.

In some embodiments, including any of the foregoing, the H₂O is changed after the first stage from steam to liquid, from vapor to liquid, from liquid to steam, from liquid to vapor, or a combination thereof.

In some embodiments, including any of the foregoing, the first stage includes using steam in combination with CO₂.

In some embodiments, including any of the foregoing, the process includes forming hydrated calcium carbonates, hydrated magnesium carbonates, or a combination thereof, in the concrete mixture.

In some embodiments, including any of the foregoing, the process includes forming hydrated calcium carbonates, hydrated magnesium carbonates, or a combination thereof, in the porous space of the concrete in the concrete mixture.

In some embodiments, including any of the foregoing, the process includes diffusing a CO₂-containing gas and water vapor streams through porous space in the concrete.

In some embodiments, including any of the foregoing, the process includes simultaneously diffusing a CO₂-containing gas and liquid water through porous space in the concrete in the concrete mixture.

In some embodiments, including any of the foregoing, the process includes simultaneously diffusing a CO₂-containing gas and water vapor through porous space in the concrete.

In some embodiments, including any of the foregoing, the process includes changing the form of water after stage one, wherein the form of water is selected from liquid, vapor or steam.

In some embodiments, including any of the foregoing, the concrete mixture includes up to 50% by mass reactive lime and reactive magnesium.

In some embodiments, including any of the foregoing, the concrete mixture includes up to 50% by mass of a combination of reactive lime, reactive magnesium, and sulfate.

In some embodiments, including any of the foregoing, the sulfate is selected from gypsum.

In some embodiments, including any of the foregoing, the process includes including adjusting the rate of microstructure development of the concrete mixture.

In some embodiments, including any of the foregoing, the process includes modulating the porosity, the microstructure, the rate of microstructure development, or a combination thereof, in the concrete mixture by: adjusting compaction extent to set the initial porosity of the concrete mixture; adding porosity-enhancing admixtures to the concrete mixture to set the initial porosity of the concrete mixture; adding porous aggregates to set the initial porosity of the concrete mixture; adding additives and admixtures to set the rate of microstructure development of the concrete mixture; or a combination of steps (a), (b), (c), and (d).

In some embodiments, including any of the foregoing, the process includes adding porosity-enhancing admixtures to set the initial porosity of the concrete mixture.

In some embodiments, including any of the foregoing, the process includes providing an amount of reactive CaO or reactive MgO to the concrete mixture to set the initial porosity and the rate of microstructure development of concrete mixture.

In some embodiments, including any of the foregoing, the concrete mixture includes about 0.5% to about 25% by mass reactive CaO, reactive MgO, or a combination thereof.

In some embodiments, including any of the foregoing, the concrete mixture includes 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, or 25%, by mass reactive CaO, reactive MgO, or a combination thereof.

In some embodiments, including any of the foregoing, the initial porosity of the concrete mixture ranges from about 1% to about 30% by volume.

In some embodiments, including any of the foregoing, the process includes compacting the concrete mixture at about 1 MPa to about 30 MPa of pressure.

In some embodiments, including any of the foregoing, the concrete mixture includes about 1% to about 50% by mass porous aggregates relative to the total amount of solid materials in the concrete mixture.

In some embodiments, including any of the foregoing, the concrete mixture includes about 0.01% to about 5% by mass porosity enhancing admixtures.

In some embodiments, including any of the foregoing, the concrete mixture has a rate of microstructure development that is delayed from about 5 min to about 24 hours by using set-retarding admixtures, stabilizing admixtures or a combination thereof during the hydrothermal densification process.

In some embodiments, including any of the foregoing, the concrete mixture includes about 0.01% to about 5% by mass set-retarding admixtures, stabilizing admixtures, brine waste material, and sulfate additives.

In some embodiments, including any of the foregoing, the brine waste material includes calcium, magnesium, sulfate, chloride or combination thereof.

In some embodiments, including any of the foregoing, the amount of hydration products or carbonate products is a function of reaction residence time, reaction temperature, relative humidity of the reaction, gas flow rate, and CO₂ concentration of a contacting CO₂-water stream in the hydrothermal reaction process.

In some embodiments, including any of the foregoing, the process occurs in a carbonation reactor.

In some embodiments, including any of the foregoing, the process occurs at about 30° C. to about 60° C. during the first stage.

In some embodiments, including any of the foregoing, the process occurs at about 30° C. to about 40° C. during the first stage.

In some embodiments, including any of the foregoing, the process occurs at about 40° C. to about 80° C. during the second stage.

In some embodiments, including any of the foregoing, the process occurs at about 60° C. to about 80° C. during the second stage.

In some embodiments, including any of the foregoing, the process occurs in a carbonation reactor.

In some embodiments, including any of the foregoing, the first stage of the process occurs at atmospheric pressure.

In some embodiments, including any of the foregoing, the second stage of the process occurs at atmospheric pressure.

In some embodiments, including any of the foregoing, wherein the process includes adjusting the rate of concrete setting by adding set retarding admixtures and/or stabilizers.

In some embodiments, including any of the foregoing, the process includes delaying the rate of concrete setting by adding set retarding admixtures and/or stabilizers.

In some embodiments, including any of the foregoing, the process includes generating additional free space in the concrete by incorporating porous aggregates generates.

In some embodiments, including any of the foregoing, the concrete mixture has a bonding matrix, and the bonding matrix includes layers of hydration and carbonate products around the surface of reactants selected from CaO particles, MgO particles, or a combination thereof.

In some embodiments, including any of the foregoing, the CaO particles, MgO particles, or a combination thereof include calcium hydroxide, magnesium hydroxide, calcium carbonates, and magnesium carbonates, or a combination thereof.

In some embodiments, including any of the foregoing, the bonding matrix further includes calcium-silicate hydrate (C—S—H), calcium-alumina-silicate hydrate (C-A-S-H), hydrous silica gel compounds, or a combination thereof.

In some embodiments, including any of the foregoing, the concrete mixture includes carbonate products selected from calcium carbonate, magnesium carbonate, or a combination thereof.

In some embodiments, including any of the foregoing, the calcium carbonate compounds include vaterite, aragonite, calcite, or a combination thereof.

In some embodiments, including any of the foregoing, the concrete mixture includes lime and/or magnesia materials ranging from about 1% to about 40% by mass.

In some embodiments, including any of the foregoing, the process includes using a CO₂-containing gas effluent gas from a source that includes carbon dioxide (CO₂).

In some embodiments, including any of the foregoing, the process includes using a CO₂-containing gas selected from an industrial CO₂-containing gas stream, dilute flue gas stream, a concentrated CO₂ gas stream, or biomass-derived CO₂.

In some embodiments, including any of the foregoing, the process includes using a CO₂-containing gas selected from atmospherically derived CO₂ or direct air capture CO₂.

In some embodiments, including any of the foregoing, the process includes using a CO₂-containing gas selected from combined heat power derived CO₂ or steam generator derived CO₂.

In some embodiments, including any of the foregoing, the concrete mixture includes alkaline-rich mineral materials.

In some embodiments, including any of the foregoing, the alkaline-rich mineral materials are selected from the group consisting of concrete wastes, reactive magnesium-based materials, desalination brine waste streams, Ca(OH)₂, lime kiln dust, lime, hydrated lime, cement kiln dust, calcium-rich coal combustion residues, slag, steel slag, iron slag, dolomitic lime, carbide lime, off-spec fly ashes, off-spec limes, calcium-rich fly ashes, calcium-poor fly ashes, biomass ashes, ponded ashes, landfilled ashes, bottom ashes, flue gas ashes, biomass ashes, fluidized bed combustion ashes, circulating fluidized bed ashes, sorbent residues, scrubbing residues, mineral sorbent/scrubbing residues including anhydrous CaO and/or Ca(OH)2, and combinations thereof.

In some embodiments, including any of the foregoing, the concrete mixture includes an admixture or an additive.

In some embodiments, including any of the foregoing, admixture or an additive is selected from the group consisting of surfactants, amines, alcohols, glycols, carboxylic acids, triethanolamine (TEA), triisopropanolamine (TIPA), diethylene glycol (DEG), triethylene glycol (TEG), ethanol (EtOH), n-Heptanoic acid (HepAc), ammonium chloride, sodium lauryl sulfate (SLS), N-trimethyl ammonium bromide (CTAB), poly-carboxylate ether (PCE), and diethylisopropanolamine (DEIPA).

In some embodiments, including any of the foregoing, the concrete mixture includes a set retarding admixture selected from the group consisting of lignosulphonates, carboxylic acids, phosphonates, sugars, phosphorus-containing organic acid salts, lignin, borax, tartaric acid, and salts thereof.

In some embodiments, including any of the foregoing, the concrete mixture includes porosity-enhancing admixtures selected from the group consisting of surfactants, foaming agents, carboxylic acid, sulfonic acid, synthetic detergents, vinsol resins, sulfonated lignin, salts of sulfonated lignin, salts of petroleum acids, salts of proteinaceous material, fatty acids, resinous acids, salts thereof, alkylbenzene sulfonates, and salts of sulfonated hydrocarbons.

In some embodiments, including any of the foregoing, the concrete mixture includes porous aggregates selected from slag aggregate, expanded clay, bottom ash, pumice, shale, perlite, biochar, cinders, rice husk, slate, and combinations thereof.

In some embodiments, including any of the foregoing, the process includes contacting the concrete mixture with a CO₂-containing flue gas stream having a temperature that ranges from about 20° C. to about 100° C.

In some embodiments, including any of the foregoing, the concrete mixture includes a mixture of water, reactive CaO, reactive MgO, hydraulic-carbonating binder system, cement, calcium carbonates, natural pozzolans, aluminosilicate materials, and additives for precast and/or cast-in-place concrete.

In some embodiments, including any of the foregoing, the additives for precast and/or cast-in-place concrete include ready mix concrete.

In some embodiments, including any of the foregoing, the process generates calcium silicate and calcium aluminate hydrates, carboaluminate phases as well as AFt and AFm phases.

In some embodiments, including any of the foregoing, the concrete mixture includes lime and/or magnesia-rich minerals, cement, aggregates, alkaline minerals, aluminosilicate minerals, and water.

In some embodiments, including any of the foregoing, the concrete mixture includes a blend of aluminosilicate and alkaline-rich mineral materials.

In some embodiments, including any of the foregoing, mineral sorbent residue is obtained by contacting a mineral sorbent with an atmospheric carbon dioxide source.

In some embodiments, including any of the foregoing, aluminosilicate mineral is collected from industrial solid wastes including coal combustion residues (e.g., class C fly ash, class F fly ashes), ponded ashes, landfilled ashes, bottom ashes, biomass ashes, fluidized bed combustion ashes, circulating fluidized bed ashes, flue gas ashes, flue gas gypsum, cement kiln dust, and slag (e.g., basic oxygen furnace slag, electric arc furnace slag, ladle slag, or blast furnace slag).

In some embodiments, including any of the foregoing, the process produces carbonate products selected from calcite, vaterite, aragonite, and combinations thereof.

In some embodiments, including any of the foregoing, the process produces carbonate products that include at least one of calcite, vaterite, aragonite, magnesite, amorphous calcium carbonates, or a combination thereof.

In some embodiments, including any of the foregoing, the concrete mixture includes reactive lime-containing materials, reactive magnesia-containing materials, or a combination thereof.

In some embodiments, including any of the foregoing, the concrete mixture includes reactive CaO, reactive MgO, or a combination thereof.

In some embodiments, including any of the foregoing, the process produces hydrated calcium carbonates, hydrated magnesium carbonates, or a combination thereof.

In some embodiments, including any of the foregoing, the concrete mixture includes porous aggregates.

In some embodiments, including any of the foregoing, the concrete mixture up to 25% by mass includes porous aggregates.

In some embodiments, including any of the foregoing, the concrete mixture includes clay aggregates.

In some embodiments, including any of the foregoing, the concrete mixture includes porosity-creating admixtures.

In some embodiments, including any of the foregoing, the concrete mixture includes air-entraining admixtures selected from the group consisting of surfactants and foaming agents.

In some embodiments, including any of the foregoing, the concrete mixture includes LKD, cement, fly ash, and natural aggregates.

In some embodiments, including any of the foregoing, the concrete mixture includes reactive lime waste, fly ash, and natural aggregates.

In some embodiments, including any of the foregoing, the concrete mixture includes set retarding and stabilizing admixtures selected from the group consisting of lignosulphonates, carboxylic, or phosphorus-containing organic acid-based admixtures.

In some embodiments, including any of the foregoing, the concrete mixture includes porous lightweight aggregate.

In some embodiments, including any of the foregoing, the concrete mixture includes about 5% to 50% by mass porous lightweight aggregate.

In some embodiments, including any of the foregoing, the concrete mixture includes up to 50% by mass reactive CaO and [SO₃].

In some embodiments, including any of the foregoing, the concrete mixture includes up to 50% by mass reactive CaO and gypsum.

In some embodiments, including any of the foregoing, the concrete mixture includes about 22% by mass porous lightweight aggregate.

In some embodiments, including any of the foregoing, the concrete mixture has a porosity of sample between 3 and 30% by volume before the hydrothermal densification process.

In some embodiments, including any of the foregoing, the process increases the strength of the concrete mixture by 25%.

In some embodiments, including any of the foregoing, the process increases the initial porosity of the concrete mixture by about 9%.

In some embodiments, including any of the foregoing, the process increase the density of the concrete mixture by 8%.

In some embodiments, including any of the foregoing, the process occurs in a carbonation reactor.

In some embodiments, including any of the foregoing, the CO2-containing gas is not conditioned.

Concrete formed by a process disclosed herein.

A concrete binder, concrete mixture, hydrated concrete, or concrete product made by a process disclosed herein.

In some embodiments, set forth herein is a concrete mixture, including: up to 50% by mass reactive CaO, reactive MgO, or gypsum; and at least one member selected from hydrated calcium carbonate, hydrated magnesium carbonate, or a combination thereof.

In some embodiments, set forth herein is a concrete mixture, including: up to 50% by mass reactive CaO, reactive MgO, or gypsum; and at least one member selected from hydrated lime, hydrated magnesia, or a combination thereof.

In some embodiments, including any of the foregoing, the concrete mixture includes reactive lime content in concrete at more than 5% by mass of total binder.

In some embodiments, including any of the foregoing, the concrete mixture includes porosity-enhancing admixtures.

In some embodiments, including any of the foregoing, the concrete mixture includes porous aggregates.

In some embodiments, including any of the foregoing, the concrete mixture includes additives and admixtures.

In some embodiments, including any of the foregoing, the concrete mixture includes an amount of reactive CaO or reactive MgO set the initial porosity and the rate of microstructure development of the concrete mixture.

In some embodiments, including any of the foregoing, the concrete mixture includes about 0.5% to about 25% by mass reactive CaO, reactive MgO, or a combination thereof.

In some embodiments, including any of the foregoing, the concrete mixture includes 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, or 25%, by mass reactive CaO, reactive MgO, or a combination thereof.

In some embodiments, including any of the foregoing, the initial porosity of the concrete mixture ranges from about 1% to about 30% by volume.

In some embodiments, including any of the foregoing, the concrete mixture includes about 1% to about 50% by mass porous aggregates relative to the total amount of solid materials in the concrete mixture.

In some embodiments, including any of the foregoing, the concrete mixture about 0.01% to about 5% by mass porosity enhancing admixtures.

In some embodiments, including any of the foregoing, the concrete mixture has a rate of microstructure development that is delayed from about 5 min to about 24 hours by using set-retarding admixtures, stabilizing admixtures or a combination thereof during the hydrothermal densification process.

In some embodiments, including any of the foregoing, the concrete mixture about 0.01% to about 5% by mass set-retarding admixtures, stabilizing admixtures, brine waste material, and sulfate additives.

In some embodiments, including any of the foregoing, the brine waste material includes calcium, magnesium, sulfate, chloride or combination thereof.

In some embodiments, including any of the foregoing, the concrete mixture includes set retarding admixtures and/or stabilizers.

In some embodiments, including any of the foregoing, the concrete mixture includes porous aggregates generates.

In some embodiments, including any of the foregoing, the concrete mixture has a bonding matrix, and the bonding matrix includes layers of hydration and carbonate products around the surface of reactants selected from CaO particles, MgO particles, or a combination thereof.

In some embodiments, including any of the foregoing, the concrete mixture includes CaO particles, MgO particles, or a combination thereof.

In some embodiments, including any of the foregoing, the concrete mixture includes calcium hydroxide, magnesium hydroxide, calcium carbonates, and magnesium carbonates, or a combination thereof.

In some embodiments, including any of the foregoing, the concrete mixture includes a bonding matrix that further includes calcium-silicate hydrate (C—S—H), calcium-alumina-silicate hydrate (C-A-S-H), hydrous silica gel compounds, or a combination thereof.

In some embodiments, including any of the foregoing, the concrete mixture includes carbonate products selected from calcium carbonate, magnesium carbonate, or a combination thereof.

In some embodiments, including any of the foregoing, the calcium carbonate compounds include vaterite, aragonite, calcite, or a combination thereof.

In some embodiments, including any of the foregoing, the concrete mixture includes lime and/or magnesia materials ranging from about 1% to about 40% by mass.

In some embodiments, including any of the foregoing, the concrete mixture includes alkaline-rich mineral materials.

In some embodiments, including any of the foregoing, the alkaline-rich mineral materials are selected from the group consisting of concrete wastes, reactive magnesium-based materials, desalination brine waste streams, Ca(OH)2, lime kiln dust, lime, hydrated lime, cement kiln dust, calcium-rich coal combustion residues, slag, steel slag, iron slag, dolomitic lime, carbide lime, off-spec fly ashes, off-spec limes, calcium-rich fly ashes, calcium-poor fly ashes, biomass ashes, ponded ashes, landfilled ashes, bottom ashes, flue gas ashes, biomass ashes, fluidized bed combustion ashes, circulating fluidized bed ashes, sorbent residues, scrubbing residues, mineral sorbent/scrubbing residues including anhydrous CaO and/or Ca(OH)₂, and combinations thereof.

In some embodiments, including any of the foregoing, the concrete mixture includes an admixture or an additive.

In some embodiments, including any of the foregoing, the admixture or an additive is selected from the group consisting of surfactants, amines, alcohols, glycols, carboxylic acids, triethanolamine (TEA), triisopropanolamine (TIPA), diethylene glycol (DEG), triethylene glycol (TEG), ethanol (EtOH), n-Heptanoic acid (HepAc), ammonium chloride, sodium lauryl sulfate (SLS), N-trimethyl ammonium bromide (CTAB), poly-carboxylate ether (PCE), and diethylisopropanolamine (DEIPA).

In some embodiments, including any of the foregoing, the concrete mixture includes a blend of aluminosilicate and alkaline-rich mineral materials.

In some embodiments, including any of the foregoing, the concrete mixture includes a set retarding admixture selected from the group consisting of lignosulphonates, carboxylic acids, phosphonates, sugars, phosphorus-containing organic acid salts, lignin, borax, tartaric acid, and salts thereof.

In some embodiments, including any of the foregoing, the concrete mixture includes porosity-enhancing admixtures selected from the group consisting of surfactants, foaming agents, carboxylic acid, sulfonic acid, synthetic detergents, vinsol resins, sulfonated lignin, salts of sulfonated lignin, salts of petroleum acids, salts of proteinaceous material, fatty acids, resinous acids, salts thereof, alkylbenzene sulfonates, and salts of sulfonated hydrocarbons.

In some embodiments, including any of the foregoing, the concrete mixture includes porous aggregates selected from slag aggregate, expanded clay, bottom ash, pumice, shale, perlite, biochar, cinders, rice husk, slate, and combinations thereof.

In some embodiments, including any of the foregoing, the concrete mixture includes a mixture of water, reactive CaO, reactive MgO, hydraulic-carbonating binder system, cement, calcium carbonates, natural pozzolans, aluminosilicate materials, and additives for precast and/or cast-in-place concrete.

In some embodiments, including any of the foregoing, the additives for precast and/or cast-in-place concrete include ready mix concrete.

In some embodiments, including any of the foregoing, the concrete mixture includes calcium silicate and calcium aluminate hydrates, carboaluminate phases as well as AFt and AFm phases.

In some embodiments, including any of the foregoing, the concrete mixture includes lime and/or magnesia-rich minerals, cement, aggregates, alkaline minerals, aluminosilicate minerals, and water.

In some embodiments, including any of the foregoing, the aluminosilicate mineral is collected from industrial solid wastes including coal combustion residues (e.g., class C fly ash, class F fly ashes), ponded ashes, landfilled ashes, bottom ashes, biomass ashes, fluidized bed combustion ashes, circulating fluidized bed ashes, flue gas ashes, flue gas gypsum, cement kiln dust, and slag (e.g., basic oxygen furnace slag, electric arc furnace slag, ladle slag, or blast furnace slag).

In some embodiments, including any of the foregoing, the concrete mixture includes carbonate products selected from calcite, vaterite, aragonite, and combinations thereof.

In some embodiments, including any of the foregoing, the concrete mixture includes carbonate products that include at least one of calcite, vaterite, aragonite, magnesite, amorphous calcium carbonates, or a combination thereof.

In some embodiments, including any of the foregoing, the vaterite as spherically shaped particles in concrete.

In some embodiments, including any of the foregoing, the calcite as cubic-shaped particles in concrete.

In some embodiments, including any of the foregoing, the aragonite as needle-shaped particles in concrete.

In some embodiments, including any of the foregoing, the concrete mixture includes a mixture of calcite, vaterite, aragonite, or a combination thereof.

In some embodiments, including any of the foregoing, the concrete mixture includes reactive lime-containing materials, reactive magnesia-containing materials, or a combination thereof.

In some embodiments, including any of the foregoing, wherein the concrete mixture includes reactive CaO, reactive MgO, or a combination thereof.

In some embodiments, including any of the foregoing, the concrete mixture includes up to 25% by mass includes porous aggregates.

In some embodiments, including any of the foregoing, the concrete mixture includes clay aggregates.

In some embodiments, including any of the foregoing, the concrete mixture includes porosity-creating admixtures.

In some embodiments, including any of the foregoing, the concrete mixture includes air-entraining admixtures selected from the group consisting of surfactants and foaming agents.

In some embodiments, including any of the foregoing, the concrete mixture includes LKD, cement, fly ash, and natural aggregates.

In some embodiments, including any of the foregoing, the concrete mixture includes reactive lime waste, fly ash, and natural aggregates.

In some embodiments, including any of the foregoing, the concrete mixture includes set retarding and stabilizing admixtures selected from the group consisting of lignosulphonates, carboxylic, or phosphorus-containing organic acid-based admixtures.

In some embodiments, including any of the foregoing, the concrete mixture includes porous lightweight aggregate.

In some embodiments, including any of the foregoing, the concrete mixture includes about 5% to 50% by mass porous lightweight aggregate.

In some embodiments, including any of the foregoing, the concrete mixture includes up to 50% by mass reactive CaO and [SO₃].

In some embodiments, including any of the foregoing, the concrete mixture includes up to 50% by mass reactive CaO and gypsum.

In some embodiments, including any of the foregoing, the concrete mixture includes about 22% by mass porous lightweight aggregate.

In some embodiments, set forth herein is an apparatus for a multi-stage carbonation process, including: at least one carbonation chamber; at least one steam generator coupled to the at least one carbonation chamber in an open-loop configuration; and at least CO₂ enrichment system coupled to the at least one carbonation chamber in a closed-loop configuration.

In some embodiments, including any of the foregoing, the steam generator is a biomass burning apparatus.

In some embodiments, including any of the foregoing, the steam generator is a natural gas burning apparatus.

In some embodiments, including any of the foregoing, the CO₂ enrichment system is a pressurized tank of CO₂.

In some embodiments, including any of the foregoing, the concentration of CO₂ from the at least one steam generator is 3% to 10% by volume.

In some embodiments, including any of the foregoing, the concentration of CO₂ from the at least one CO₂ enrichment device is 5% to 25% by volume.

In some embodiments, including any of the foregoing, the concentration of CO₂ from the at least one CO₂ enrichment device is higher than the concentration of CO₂ from the at least one steam generator.

In some embodiments, including any of the foregoing, the concrete mixture comprises a blend of aluminosilicate and alkaline-rich mineral materials.

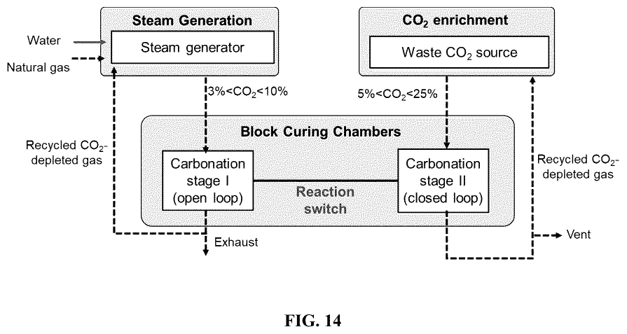

FIG. 14 shows an embodiment in accordance with the disclosure herein. FIG. 14 shows at least one block curing chambers. Additional chambers, not shown, may also be included. FIG. 14 shows a device or apparatus for generating steam. The device or apparatus for generating steam may also generate CO₂. The device or apparatus for generating steam and/or CO₂ may burn natural gas to generate steam feed water and/or CO₂. The device or apparatus for generating steam and/or CO₂ is coupled to the at least one block curing chambers in a configuration for an open-loop circulation process. The open-loop includes an exhaust and a line for recycling CO₂ depleted gas. In some embodiments, the CO₂ concentration is between 3% and 10% by volume in the CO₂-containing gas from the device or apparatus for generating steam and/or CO₂. FIG. 14 shows a device or apparatus for CO₂ enrichment. In some embodiments, the CO₂ concentration is between 5% and 25% by volume in the CO₂-containing gas from the device or apparatus for CO₂ enrichment. The device or apparatus for CO₂ enrichment is coupled to the at least one block curing chambers in a configuration for a closed-loop circulation process. The closed-loop includes a vent and a line for recycling CO₂ depleted gas.

### EXAMPLES

### Example 1

This Example shows the effects of water content and processing conditions, such as temperature (herein “T”; ° C.) and relative humidity (herein “RH”), on the reactivity and hydration kinetics of alkaline-rich minerals. A large rise in temperature during concrete curing is a problem and may lead to cracking.

In this example, lime kiln dust (herein “LKD”) was used as an alkaline-rich mineral. Two different LKDs with different free lime (CaO) contents (i.e., reactive lime amount) were used (Table 1). In this example, LKD materials were used as-is without any pre-treatment or pre-carbonation. This example shows the relationship between the water content required for full hydration and the corresponding heat release of LKD as a function of free CaO content. The amount of heat released is indicative of the amount of heat released when LKD is used to make concrete and the potential for the concrete to crack.

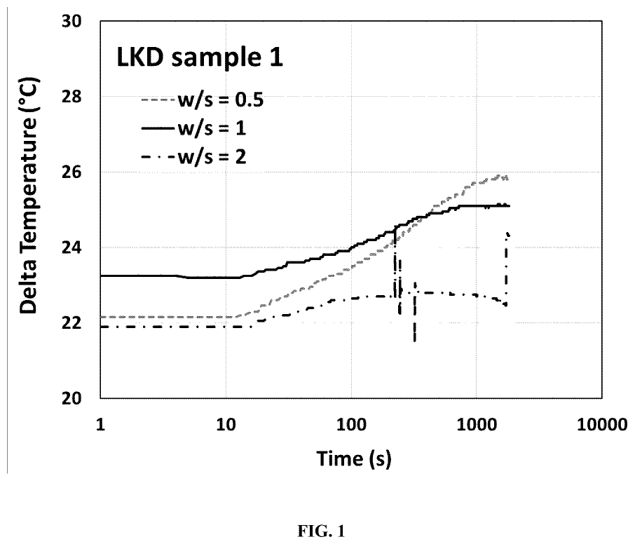

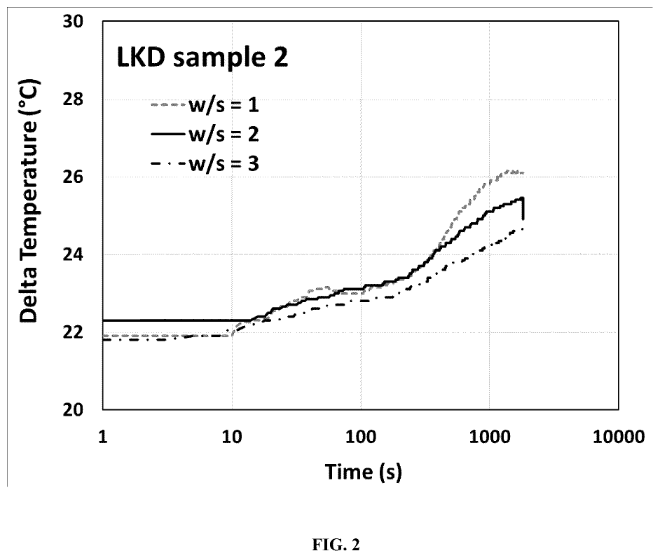

The reactivity of samples was measured based on heat release as a function of time using the water extinction test following the European standard procedure (NF EN 549-2, 2002); a mass of 150 g of lime is introduced into 600 g of water in an adiabatic flask and agitated by a magnetic stirrer. A thermometer was placed in the suspension to measure the temperature of the suspension, which increases due to the heat released during the hydration of CaO and then reaches a plateau to a final value (maximum temp rise). Thermogravimetric analysis (TGA; STA 6000, Perkin Elmer) was used to assess the extent of Ca(OH)₂ before and after full hydration to estimate the extent of conversion of CaO to Ca(OH)₂ following the hydration reaction. Around 40 mg of powder was heated from 35° C. to 975° C. at 15° C./min in an aluminum oxide crucible and under a 20 mL/min ultra-high purity N₂ purge. The Ca(OH)₂ content was quantified by assessing the mass loss due to dihydroxylation from the hydrated powder over the temperature range from 300° C. to 500° C. The results indicate that the water content required to achieve full hydration and their corresponding heat release is related to free lime content of alkaline-rich materials (See FIGS. 1 and 2; and Tables 2 and 3). This example shows that CaO is more reactive than MgO based on the observed temperature rise. This example indicates that the time required to achieve full hydration in LKD samples varies with water content. This analysis can help inform the water requirement when LKD is used as a reactant in concrete mixtures. The amount of hydration can be estimated from Table 3. During LKD hydration, lime (CaO) is converted to calcium hydroxide (Ca(OH)₂).

TABLE 1
Bulk composition of two LKD samples as determined
by X-ray fluorescence (XRF) analysis (wt. %)

| Sample | CaO | MgO | Al₂O₃ | SiO₂ | SO₃ |
|---|---|---|---|---|---|
| LKD sample 1 | 59.07 | 42.2 | 0.25 | 0.48 | 0.17 |
| LKD sample 2 | 77.1 | 3.89 | 2.57 | 5.34 | 8.48 |

TABLE 2
Complete hydration time of two LKD samples that are suspended
in water as a function of time using the water extinction test
following the European standard procedure (NF EN 549-2, 2002).

| | Water/solid | Complete hydration |
|---|---|---|
| Sample | by mass ratio | time (second) |
| LKD sample 1 | 0.5 | 815 |
| | 1 | 419 |
| | 2 | 190 |
| LKD sample 2 | 1 | 1240 |
| | 2 | 1078 |
| | 3 | 784 |

TABLE 3
Conversion of lime (CaO) to calcium hydroxide
(Ca(OH)₂) of two LKD samples after complete hydration
as determined by thermogravimetric analysis (TGA)

| | Ca(OH)₂ % by weight | Ca(OH)₂ % by weight |
|---|---|---|
| Sample | before hydration | after hydration |
| LKD sample 1 | 6.99 | 22.19 |
| LKD sample 2 | 19.92 | 42.53 |

### Example 2

This Example shows the effects of water content and processing conditions, such as temperature and relative humidity, on the carbonation kinetics of alkaline-rich minerals. In this example, lime kiln dust was used as an alkaline-rich mineral. In this example, LKD material was used as-is without any pre-treatment or pre-carbonation.

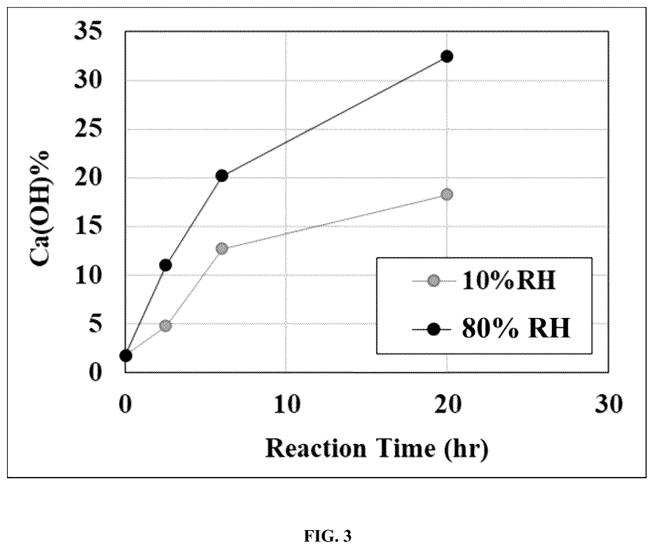

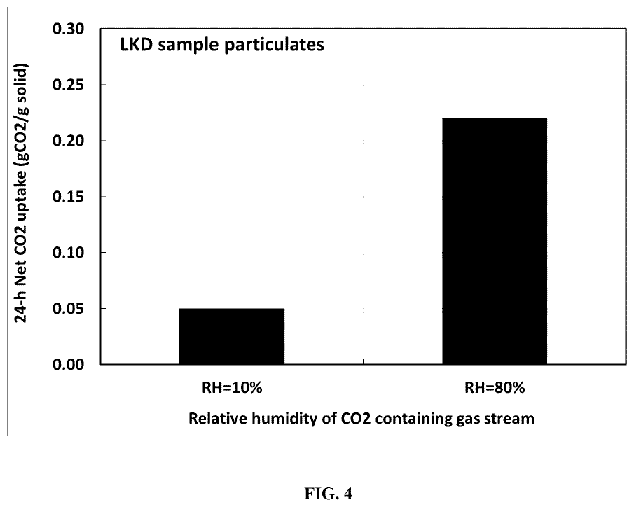

A flow-through reactor was used to expose the LKD in the form of particulates at controlled temperatures (T), relative humidities (RH), and CO₂ concentrations [CO₂]. The reactors were housed horizontally in a digitally controlled oven for temperature control. The reactor was instrumented to monitor relative humidity (RH) and temperature (T). Dry gas mixtures with varying CO₂ concentrations were prepared by mixing air and CO₂ at prescribed flow rates using mass flow controllers. To control RH, the dry gas mixtures were humidified by bubbling the gas through washing bottles housed in a separate oven, the temperature of which was controlled to achieve the desired RH within the feed gas stream. The LKD reactants were exposed to 8-12% CO₂ by volume, 35° C. to 50° C., 10% RH to 80% RH, and flow rates of 1-5 standard liters per minute (slpm). Thermogravimetric analysis (TGA; STA 6000, Perkin Elmer) was used to assess the extent of carbonation experienced by the powder reactants. Around 40 mg of carbonated powder was heated from 35° C. to 975° C. at 15° C./min in an aluminum oxide crucible and under a 20 mL/min ultra-high purity N₂ purge. The CO₂ uptake was quantified by assessing the mass loss from the carbonated powder that is associated with CaCO₃ decomposition over the temperature range from 550° C. to 900° C., normalized by the mass of the initially dry powder placed in the TGA. FIG. 3 shows the CO₂ uptake of LKD particulates after twenty (20) hours of exposure to 12% CO₂ by volume as a function of time at T=40-50° C. and RH=10-80%. This example shows that lime-CO₂ carbonation in the dry state is very slow and limited in that carbonation proceeds via a gas-solid reaction. The gas-solid reaction is hindered by surface passivation/barrier formation on surfaces of reactants (lime). When the water in the form of liquid or vapor is present, lime (CaO) is converted into calcium hydroxide (Ca(OH)₂) (FIG. 3) and then can get carbonated rapidly following exposure to CO₂ gas stream via a dissolution-precipitation pathway. This eventually results in near complete conversion (carbonation) of lime (FIG. 4). Based on water content and carbonation exposure condition, the hydration, and carbonation of lime mineral can occur simultaneously and continuously.

### Example 3—Prophetic Example

This example would show the effect of the initial porosity of concrete on the hydration and carbonation kinetics of concrete mixture comprising cement, LKD, and aggregates. In this example, LKD material would be used as-is without any pre-treatment, pre-hydration, or pre-carbonation in the concrete mixture. The initial porosity content of concrete following forming/casting would be correlated with the extent of hydration and CO₂ uptake in LKD-containing concretes. This example would develop a correlation between the extent of free lime content and the initial porosity of the concrete mixture to regulate the porosity and microstructure of concrete containing free lime materials. The lime-containing concrete mixtures would be subjected to hydrothermal densification reactions comprising hydration and carbonation reactions. These reactions would solidify the concrete mixture via hydration and carbonate product formations.

The extent of free lime content would be determined using thermogravimetric analysis (TGA; STA 6000, Perkin Elmer) to assess the extent of Ca(OH)₂ before and after full hydration and estimate the extent of lime content following the hydration reaction. Around 40 mg of powder would be heated from 35° C. to 975° C. at 15° C./min in an aluminum oxide crucible and under a 20 mL/min ultra-high purity N₂ purge. The Ca(OH)₂ content would be quantified by assessing the mass loss due to dihydroxylation from the hydrated powder over the temperature range from 300° C. to 500° C. Additionally, the extent of free-lime content would be correlated to the heat of hydration of lime-containing mixtures using isothermal calorimetry and/or semi-adiabatic calorimetry.

Dry-cast concrete samples comprising LKD, cement, fly ash, and natural aggregates would be prepared by compaction using a hydraulic press to form cylindrical specimens (75 mm×75 mm; diameter (d)×height (h)) and would be contacted with a simulated flue gas stream of 12 vol % CO₂ in air. A similar set of carbonation experiments would be conducted on concrete samples that are exposed to the CO₂ gas stream as described in Example 2 to identify the CO₂ uptake potential when the concrete mixture is shaped and formed. The compressive strengths of concrete mixtures exposed to CO₂ streams will also be evaluated. The compressive strength of concrete mixtures would be measured and correlated to the extent of hydration and carbonation following exposure to the CO₂ gas stream.

The total porosity of the concrete specimens before and after carbonation would be quantified using a vacuum saturation method. Cross-sectional disks, 25 mm thick, would be sectioned from the middle of the cylindrical specimens using a low-speed saw. Isopropanol (IPA) would be used as the solvent to arrest hydration and minimize hydration progression over the course of testing. The electrical resistivity of concrete specimens would be measured to characterize the porosity of the concrete microstructure before and after the carbonation curing of cylindrical specimens. The procedures in ASTM C1876 would be used. Electrical resistivity would be an indirect measure of microstructural porosity. Electrical resistivity would be dominantly controlled by microstructural refinement, pore saturation level, and pore solution concentration. Isothermal calorimetry and/or semi-adiabatic calorimetry would be used to assess the temperature rise in concrete mixtures that include lime and magnesia during hydrothermal densification reactions that include hydration and carbonation reactions.

### Example 4—Prophetic Example

This Example would show the effects of the incorporation of porous aggregates on the extent of hydration and carbonation in lime-containing concrete mixtures following exposure to CO₂ gas stream and water vapor. In this example, LKD material would be used as-is without any pre-treatment, pre-hydration, or pre-carbonation in concrete mixtures. In this example, expanded clay aggregates (smaller than 4.75 mm) would be used as porous aggregate in a concrete mixture for up to 25% by mass of the concrete mixture. Dry-cast concrete samples comprising LKD, cement, fly ash, expanded clay aggregates, and natural aggregates would be prepared by compaction using a hydraulic press to form cylindrical specimens (75 mm×75 mm; d×h) and would be contacted with simulated flue gas stream of 12 vol % CO₂ with the mixing of air and CO₂ streams. A similar set of carbonation experiments would be conducted on concrete samples that are exposed to the CO₂ gas stream as described in Example 2 to identify the CO₂ uptake potential when the concrete mixture is shaped and formed. The compressive strengths of concrete mixtures exposed to CO₂ streams would also be evaluated.

### Example 5—Prophetic Example

This Example would show the effects of porosity-creating admixtures on the hydration and carbonation extents of lime-containing concrete mixtures following exposure to CO₂ gas stream and water vapor. Certain commercially available chemical admixtures such as air-entraining admixtures selected from the group consisting of surfactants and foaming agents would be used in concrete mixture to create stable air voids in concrete following forming and casting. In this example, LKD material would be used as-is without any pre-treatment, pre-hydration, or pre-carbonation in concrete mixtures. Dry-cast concrete samples comprising LKD, cement, fly ash, and natural aggregates would be prepared by compaction using a hydraulic press to form cylindrical specimens (75 mm×75 mm; d×h) and would be contacted with a simulated flue gas stream of 12 vol % CO₂ in air. A similar set of carbonation experiments would be conducted on concrete samples that are exposed to the CO₂ gas stream as described in Example 2 to identify the CO₂ uptake potential when the concrete mixture is shaped and formed. The compressive strengths of concrete mixtures exposed to CO₂ streams will also be evaluated.

### Example 6—Prophetic Example

This Example would show the effects of set retarding and stabilizing admixtures on hydration and carbonation extents of lime-containing concrete mixtures following exposure to CO₂ gas stream and water vapor. Certain commercially available set retarding and stabilizing chemical admixtures selected from the group consisting of lignosulphonates, carboxylic, or phosphorus-containing organic acid-based admixtures would be used in concrete mixture to retard and control the hydration of concrete. In this example, LKD material would be used as-is without any pre-treatment, pre-hydration, or pre-carbonation in concrete mixtures. Dry-cast concrete samples comprising LKD, cement, fly ash, and natural aggregates would be prepared by compaction using a hydraulic press to form cylindrical specimens (75 mm×75 mm; d×h) and would be contacted with a simulated flue gas stream of 12 vol % CO₂ in air. A similar set of carbonation experiments would be conducted on concrete samples that are exposed to the CO₂ gas stream as described in Example 2 to identify the CO₂ uptake potential when the concrete mixture is shaped and formed. The compressive strengths of concrete mixtures exposed to CO₂ streams will also be evaluated.

### Example 7—Prophetic Example

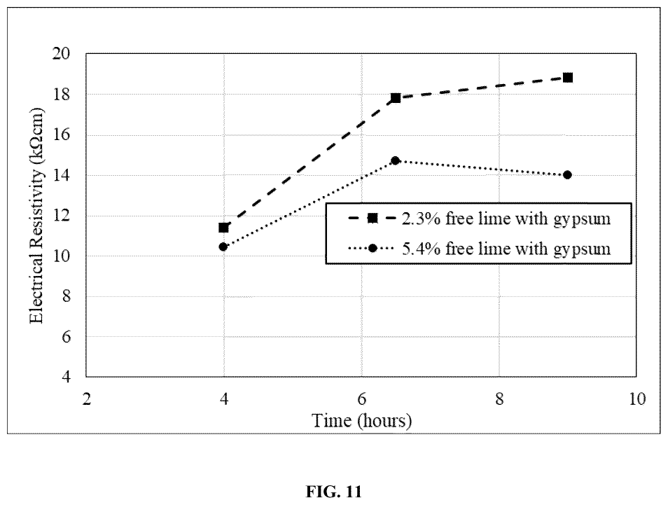

This Example would show the effects of lime-rich minerals on the densification, mechanical properties, and porosity refinement of concrete mixtures during hydration and carbonation reactions. In this example, LKD material would be used as-is without any pre-treatment, pre-hydration, or pre-carbonation in concrete mixtures. Dry-cast concrete samples comprising LKD, cement, fly ash, and natural aggregates would be prepared by compaction using a hydraulic press to form cylindrical specimens (75 mm×75 mm; d×h) and would be contacted with a simulated flue gas stream of 12 vol % CO₂ in air. A similar set of carbonation experiments would be conducted on concrete samples that are exposed to the CO₂ gas stream as described in Example 2 to identify the CO₂ uptake potential when the concrete mixture is shaped and formed. The compressive strengths of concrete mixtures exposed to CO₂ streams will also be evaluated. The electrical resistivity of concrete specimens would be measured to characterize the porosity of concrete microstructure before and after carbonation curing of cylindrical specimens following the procedures in ASTM C1876. Electrical resistivity would be an indirect measure of microstructural porosity, and it would be dominantly controlled by microstructural refinement, pore saturation level, and pore solution concentration. See FIGS. 11-13. This Example would show the correlation of porosity/compressive strength with the extent of hydration-carbonation reactions of concrete comprising lime kiln dust to develop a reaction-property relationship that can be used as a predictor to estimate material performance.

### Example 8

This Example shows the effects of the free-lime content on the heat released during hydration. In this example, reactive lime containing waste materials (LKD) were used as-is without any pre-treatment. The heat released during hydration was determined using a home-made semi-adiabatic calorimeter. Reactive lime industrial solid wastes was mixed with graded standard sand and water. The temperature of the mortar was measured using a Type-K thermocouple. The free lime content was determined using thermogravimetric analysis (TGA; STA 6000, Perkin Elmer) performed on the as-received and fully hydrated LKDs. Around 50 mg of the samples (as-received and hydrated) were heated from 35° C. to 1,000° C. at 15° C./min in an aluminum oxide crucible and under a 20 mL/min ultra-high purity N₂ purge. The Ca(OH)₂ content was quantified by assessing the mass loss due to dihydroxylation from the hydrated powder over the temperature range from 300° C. to 500° C. Back calculation was used to indirectly calculate the reactive lime content by measuring the increase in the Ca(OH)₂ content after hydration.

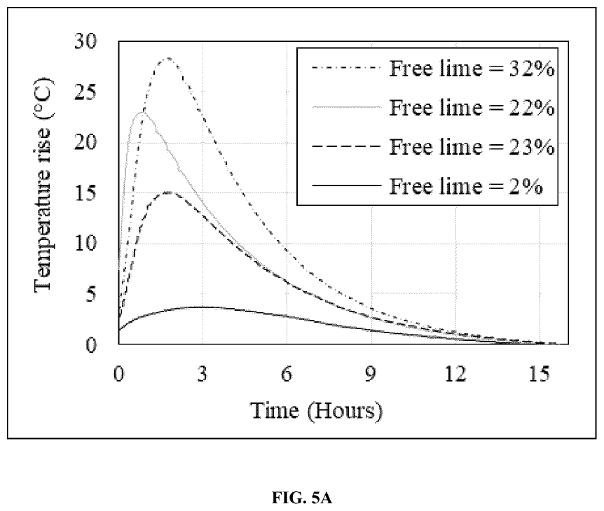

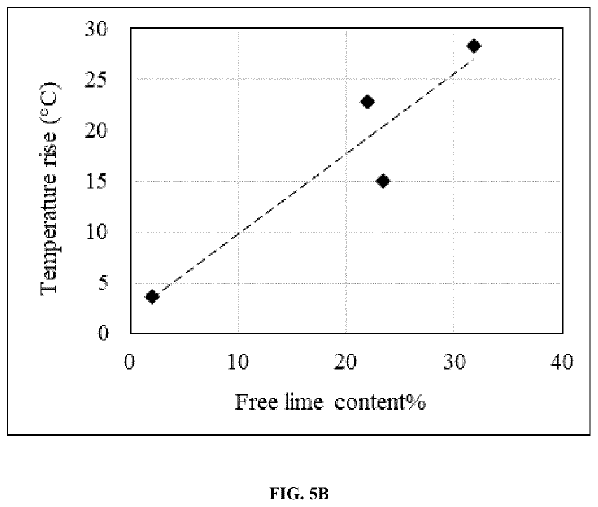

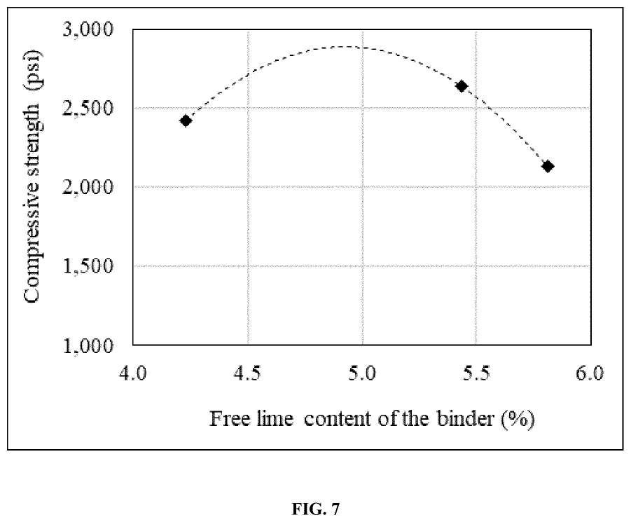

FIG. 5A shows the heat released as a function of free lime content over time. The mortar reached its maximum temperature during the first two hours, then the rate of heat released was decreased. The drop in heat released rate is attributed to the consumption of available free (reactive) lime. In addition, once the surface of the particles gets coated with the hydration products, the water diffuses into the particle core and reacts with the un-reacted free lime and becomes restricted, which results in the reduction in the reaction rate. FIG. 5B depicts the correlation between the heat of hydration and the free-lime content. The higher free-lime content in general yields a higher temperature release. The extent and rate of heat generated are correlated with the extent of reactive lime content. Further, extent of temperature rise (heat released) is an indicative of the degree of volume expansion in concrete that is curing. More heat released means the concrete is subject to more expansion and potentially to cracking. See also FIG. 7 in Example 10, which shows that a maximum in compressive strength for concrete mixture that included 5% by weight reactive lime content in the mixture.

FIG. 5A shows the effect of reactive lime content on heat of hydration of mortars containing reactive free lime waste materials, and FIG. 5B shows a correlation between reactive lime content and heat of hydration of mortar samples.

### Example 9

This Example shows the effect of the porous lightweight aggregate (LWA; https://arcosalightweight.com/) content on the early-age strength and later-age integrity of concrete containing free-lime content. In this example, reactive lime from industrial byproduct was used without any pretreatment such as pre-hydration and pre-carbonation. Dry-cast concrete samples comprising reactive lime solid waste, cement, fly ash, and natural aggregates were prepared by compaction using a hydraulic press to form cylindrical specimens (75 mm×38 mm; d×h) and was contacted with a simulated flue gas stream of 10 vol % CO₂ in air. For the first mixture, 22 wt. % LWA was used in the mix; however, no LWA was used in the second mix. Therefore, the initial porosity of the first mix was significantly higher than the second mix. The integrity of concrete at later ages was correlated to the initial porosity of concrete.

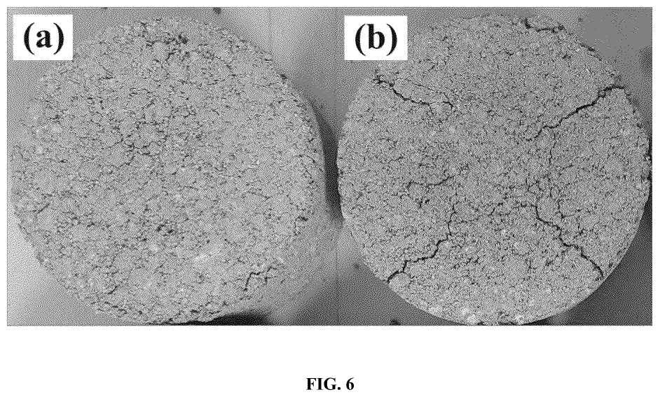

Although LWA is a porous and inherently weaker aggregate than normal-weight aggregate (https://arcosalightweight.com/), the early-age strength of the samples containing LWA was higher by around 25%. The hydrothermal densification of free lime filled the capillary voids and densified the microstructure. At later ages, the incorporation of LWA contributed to preserving the integrity of concrete samples. The incorporation of 22 weight percent (wt. %) of LWA reduced the density of the mixtures by about 8% and increased the initial porosity by about 9%. As depicted in FIG. 6A, no cracks were found for the samples containing LWA at later ages. The additional porosity provided by LWA provided extra space for the expansion of free-lime when it hydrates and reacts to form calcium hydroxide. Therefore, this volume expansion did not cause cracking, and the integrity of the concrete sample was preserved for the first mix. For the second mix, no LWA was used in the mixture, therefore, no extra porosity was provided. As depicted in FIG. 6B, major cracking was observed at later ages in this example. The volume expansion caused by the hydration of the free-lime resulted in internal and external cracking, thus integrity of the concrete sample was not preserved.

FIGS. 6A and 6B show the effect of incorporating lightweight aggregate on the integrity and cracking of mortar samples that include reactive lime materials. The left side shows a concrete cylinder with lightweight aggregate. The right side shows a concrete cylinder without lightweight aggregates and with cracking.

### Example 10

This Example shows the effects of the initial reactive lime content on the early-age compressive strength of concrete. In this example, reactive lime waste, and fly ash were used as-is without any pre-treatment or pre-carbonation.

The extent of free lime content of the raw material was determined using thermogravimetric analysis (TGA; STA 6000, Perkin Elmer). Dry-cast concrete samples comprising cement, reactive lime waste, fly ash (FA), and natural aggregates was prepared by compaction using a hydraulic press to form cylindrical specimens (75 mm×38 mm; d×h) and was contacted with a humidified flue gas stream of 7 vol % CO₂ in air. The compressive strength of concrete mixtures was measured and correlated to the extent initial free lime content of the mixture.

As the results show, by increasing the initial reactive lime content, the compressive strength of concrete increases until the free lime content reaches a threshold. After passing this threshold, the compressive strength decreases. The increase of compressive strength is attributed to the denser microstructure of concrete due to hydrothermal densification. However, after passing the threshold, the excess amount of free lime results in deterioration of the concrete performance. The volume expansion caused by the hydration of excess free-lime resulted in internal microcracking and thus reduction in compressive strength.

FIG. 7 shows a correlation between reactive lime content and compressive strength of concrete made with varying free lime contents by mass of total binder.

### Example 11

This Example shows the effect of curing process sequence by switching and adjusting the extent of vapor stream in a CO₂ containing gas stream during hydrothermal densification process on the early-age compressive strengths of concrete mixtures containing alkaline-rich minerals. In this example, Sample 2 of example 1 was used as-is without any pre-treatment or pre-carbonation. Dry-cast concrete samples comprising lime waste materials, cement, fly ash, and natural aggregates were prepared by compaction using a hydraulic press to form cylindrical specimens (75 mm×38 mm; d×h). Concrete samples were exposed to varying conditions of flue gas stream simulated by mixing air and CO₂.

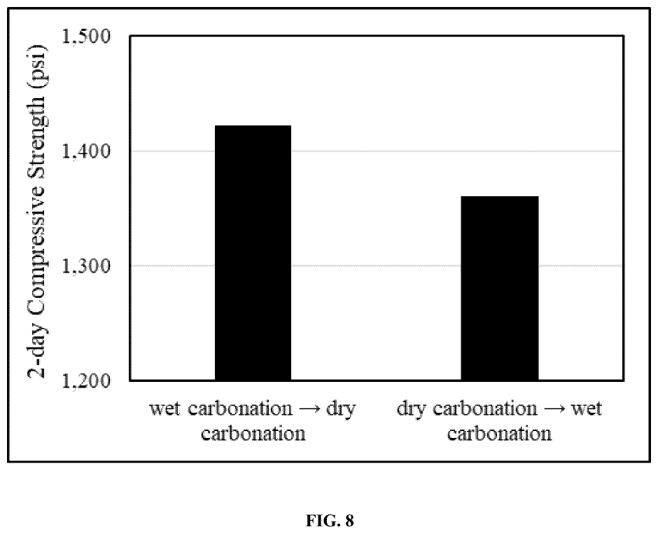

FIG. 8 shows an effect of multistage hydrothermal curing process conditions on compressive strength of concrete samples comprising reactive lime waste materials by varying water vapor and CO₂ contents at each stage. For wet carbonation, the hydrothermal process was conditioned to 7%≤CO₂≤15%, 50° C.≤T≤80° C. and 50%≤RH≤100%. For dry carbonation, the hydrothermal process was conditioned to 3%≤CO₂≤7%, 30° C.≤T≤50° C. and 20%≤RH≤50%. flow rate was set at 3 standard liters per minute (SLPM) for both stages.

FIG. 8 shows that applying wet carbonation followed by dry carbonation on concrete mixtures containing alkaline-rich minerals is favorable to early-age compressive strength. Simultaneous introduction of CO₂ and water in gas stream increases degree of hydration and carbonation concrete containing free lime waste materials that resulted in a greater compressive strength. This is attributed to: (1) wet carbonation in the beginning favors the hydration kinetics of free lime material. This allows subsequent carbonation of hydrated lime waste materials that leads to a denser microstructure due to the hydrothermal densification and (2) a lower cement hydration at the beginning of the curing process that provides more porosity for the hydrothermal densification of concrete containing reactive lime waste materials.

### Example 12

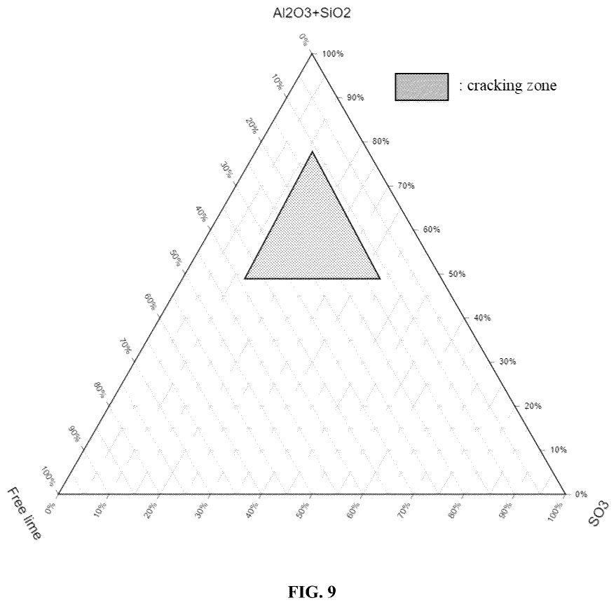

In this Example, dry-cast concrete samples including a varying amount initial reactive lime, cementitious materials, pozzolanic materials, and natural aggregates were evaluated. A ternary diagram of the following indexes—(a) Al₂O₃+SiO₂, (b) Free Lime [CaO], (c) SO₃— is plotted in FIG. 9 to correlate mixture composition to cracking induced by expansion of reactive lime waste materials.

FIG. 9 shows that mixtures within the shaded region are more prone to cracking. The crack zone could intercept the “Free lime” axis from 10% to 50%, and the “SO₃” axis from 10% to 40%. This suggests that optimal composition index of [Free lime]+[SO₃] of up to 50% (by mass of total binder) that does not lead to expansive induced cracking in concrete comprising reactive free lime waste materials. In this plot, SO₃ is a measure of the amount of gypsum in the mixture. Al₂O₃+SiO₂ is a measure of the amount of aluminosilicate material such as fly ash (or slag). Free lime is a measure of the initial reactive amount of lime (CaO).

SO₃ comes from gypsum. Gypsum reacts with alumina to form ettringite. This reaction causes expansion similar to lime hydration.

### Example 13

This Example shows the effect of additives, such as accelerating admixtures, set-retarding admixtures, and gypsum, on the microstructure and early-age strength of free lime-containing concrete mixtures. In this example, reactive lime waste material was used as-is without any pretreatment such as pre-hydration or pre-carbonation.

In this example, dry-cast concrete samples comprising free lime, cement, fly ash, natural aggregates, and additive were prepared by compaction using a hydraulic press to form cylindrical specimens (75 mm×38 mm; d×h). Concrete samples were exposed to varying conditions of hydrothermal reaction process wherein CO₂ containing gas and water vapor were mixed. The processing condition varies from 3 to 20% CO₂ by volume, 30° C. to 80° C., steam (supersaturated air stream), and flow rates of 1 to 5 standard liters per minute (slpm). The development microstructure and porosity evolution of concrete mixtures were characterized by compressive strength measurement and electrical resistivity measurement.

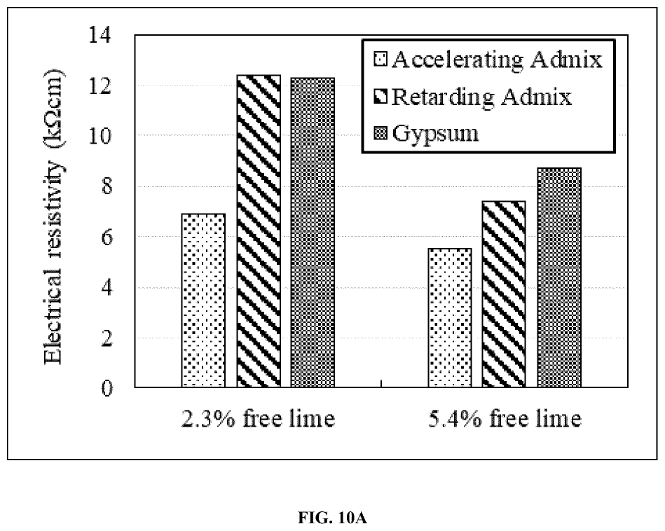

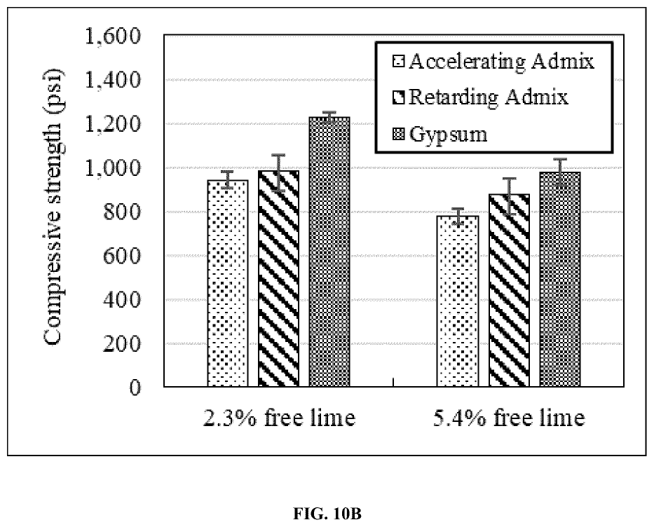

FIG. 10A shows the effect of different additives on the early-age electrical resistivity of concrete mixtures containing different free lime contents. For concrete mixtures containing low amounts (e.g., 3% by weight or less is low; 6% by weight or more is high) of free lime, the addition of accelerating admixture resulted in the lowest early-age electrical resistivity. The reduced electrical resistivity is due to expansive induced cracking with high dosage of free lime content. On the contrary, the addition of set-controlling admixtures such as retarding admixture and gypsum resulted in a higher early-age electrical resistivity. This shows the decelerating effect of the admixture on the microstructure development that can create a higher capacity to absorb expansive volume that is induced by reactive free lime materials, hence resulted in a higher early-age electrical resistivity and no cracking.

FIG. 10B shows the effect of different admixtures on the early-age compressive strengths of concrete mixtures. For concrete mixtures containing low amounts of free lime materials, the addition of accelerating admixture resulted in the lowest early-age compressive strength that is due to cracking in the concrete microstructure due to hydrothermal densification of LKD. On the contrary, the addition of set retarding admixture and gypsum resulted in a higher early-age compressive strength.

The reactive lime contents are shown in FIG. 10A. The composition included cement, aggregate, water, reactive lime waste material and additives/admixtures. The same composition was used for the results shown in FIGS. 10-13.

FIG. 11 shows the evolution of electrical resistivity during hydrothermal densification of concrete containing reactive lime with the addition of gypsum. For concrete mixtures containing low amounts of free lime with gypsum, the electrical resistivity constantly increased during the curing process. This indicates that the microstructure of the concrete is being refined during the process with no signs of cracking. However, for concrete mixtures containing high amount of free lime with gypsum, the electrical resistivity trend dropped after about 6 hours of hydrothermal densification process. The electrical resistivity drop is an indication of microstructural cracking due to free lime hydration.

As shown in FIG. 11, 2.3% and 5.4% refer to the reactive lime content in the binder. The amount of gypsum was fixed for both mixtures. FIG. 11 shows that 2.3% reactive lime mixture with gypsum performed better than 5.4% reactive lime mixture.

FIG. 11 shows the Effect of gypsum additive on electrical resistivity evolution of concrete mixtures containing reactive free limes contents during hydrothermal densification process.

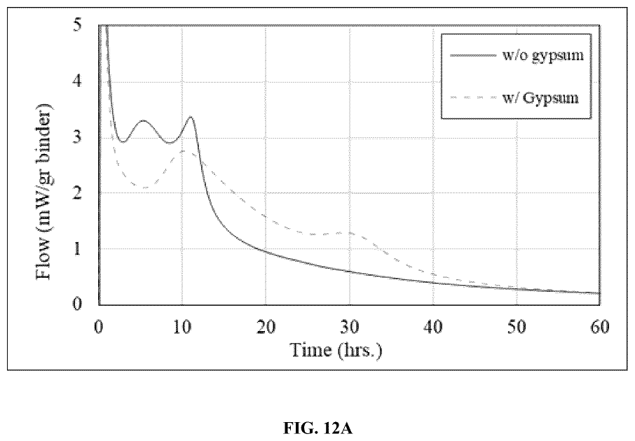

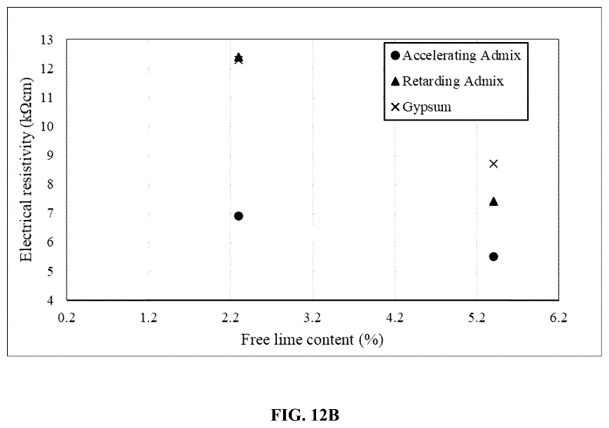

FIG. 12A shows the effect of gypsum addition on controlling hydration kinetics and rate of microstructural development of concrete mixtures containing reactive free lime. The gypsum content was set at 10% by mass of total binder content. The dormant period was increased from 4 hours to 7 hours and peak of heat decreased from 3.2 to 2.7 mw/gr of binder with gypsum addition. The lower peak heat and longer induction period of concrete mixture features a slower hydration kinetics and rate of microstructural development that was achieved in reactive lime concrete mixture when gypsum was used. FIG. 12B shows the effect of controlling the rate of microstructural development through additives (accelerating and decelerating admixtures and gypsum) of concrete mixtures made with varying free lime contents. Electrical resistivity is a measure of degree of porosity of concrete and is indicative of the degree of microstructural development of concrete mixtures.

FIG. 12B show the correlation of early-age electrical resistivity and free-lime content of concrete mixtures containing different additives. For a given amount of free-lime content, the effect of increase in early-age electrical resistivity can be observed if set-controlling admixtures such as retarding admixture (MasterSet DELVO) and gypsum are used instead of accelerating admixtures (MasterSet AC 534). The admixture dosages for accelerating and decelerating admixtures were set at 1.2% by mass of total binder content. This means that the hydrothermal densification of free lime materials can be controlled with admixtures, and that concrete mixtures with higher free-lime content could be feasible provided that set-controlling admixtures are used.

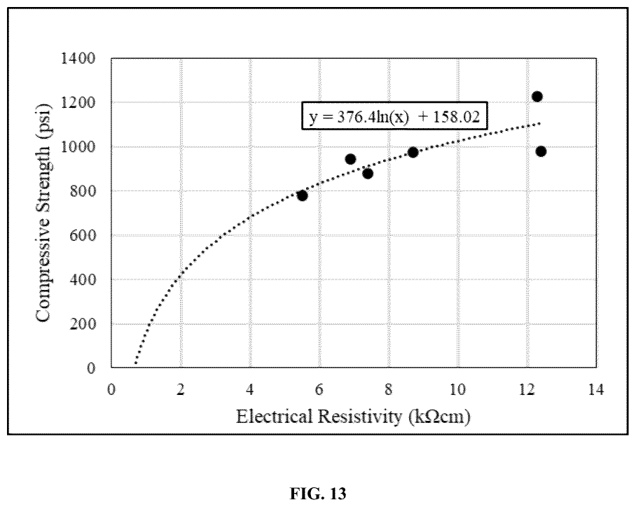

FIG. 13 shows the correlation between compressive strength and electrical resistivity for concrete mixtures containing free lime materials during hydrothermal reaction process. A logarithmic regression is fitted to the data point. Increasing electrical resistivity results from microstructural evolution of concretes that translates to compressive strength development. The increase in electrical resistivity is related to microstructural development and hydration of concrete containing free lime materials.

The compressive strength-electrical resistivity evolution relationship during hydrational reaction process can be used to predict degree of hydration of reactive free lime and onset of expansive induced cracking by excessive free lime in concrete mixtures. For example, the resistivity drops, e.g., at 5.4% free lime mixture in FIG. 11 is indicative of cracking.

The embodiments and examples described above are intended to be merely illustrative and non-limiting. Those skilled in the art will recognize or will be able to ascertain using no more than routine experimentation, numerous equivalents of specific compounds, materials, and procedures. All such equivalents are considered to be within the scope and are encompassed by the appended claims. In particular, while certain methods may have been described concerning particular operations performed in a particular order, it will be understood that these operations may be combined, subdivided, or re-ordered to form an equivalent method without departing from the teachings of the disclosure. Accordingly, unless specifically indicated herein, the order and grouping of the operations are not a limitation of the disclosure. It should be understood by those skilled in the art that various changes may be made, and equivalents may be substituted without departing from the true spirit and scope of the disclosure as defined by the appended claims. In addition, many modifications may be made to adapt a particular situation, material, composition of matter, method, operation, or operations, to the objective, spirit, and scope of the disclosure. All such modifications are intended to be within the scope of the claims appended hereto.

1. A process for making concrete, wherein the process comprises:
providing a concrete mixture comprising reactive CaO-containing materials, reactive MgO-containing materials, or a combination thereof;
adjusting the porosity, the microstructure, or both the porosity and the microstructure of the concrete mixture; and
solidifying the concrete mixture by a hydrothermal densification process in a single stage or in a multistage process by contacting the concrete mixture with a CO₂-containing gas and H₂O.

2. (canceled)

3. The process of claim 1, wherein the hydrothermal densification process is a single stage process in which the flow rate, relative humidity, CO₂ concentration, total pressure, partial pressure, or a combination thereof, are held constant during the hydrothermal densification process.

4. The process of claim 1, wherein the hydrothermal densification process is a multi-stage process in which the flow rate, relative humidity, CO₂ concentration, total pressure, partial pressure, or a combination thereof, are changed during the hydrothermal densification process.

5. The process of claim 4, wherein the hydrothermal densification process is a multi-stage process in which the CO₂ concentration, pressure, or a combination thereof, is increased after the first stage of the multi-stage process.

6.-14. (canceled)

15. The process of claim 4, comprising changing the form of water at different stages of the multistage process, wherein the form of water is selected from liquid, vapor or steam.

16. The process of claim 1, wherein the concrete mixture comprises up to 50% by mass reactive lime and reactive magnesium.

17. The process of claim 1, wherein the concrete mixture comprises up to 50% by mass of a combination of reactive lime, reactive magnesium, and sulfate.

18. The process of claim 17, wherein the sulfate is selected from gypsum.

19. (canceled)

20. The process of claim 1, further comprising modulating the porosity, the microstructure, the rate of microstructure development, or a combination thereof, in the concrete mixture by:
(a) adjusting compaction extent to set the initial porosity of the concrete mixture;
(b) adding porosity-enhancing admixtures to the concrete mixture to set the initial porosity of the concrete mixture;
(c) adding porous aggregates to set the initial porosity of the concrete mixture;
(d) adding additives and admixtures to set the rate of microstructure development of the concrete mixture; or
a combination of steps (a), (b), (c), and (d).

21. (canceled)

22. (canceled)

23. The process of claim 1, comprising providing 0.5% to 25% by mass of CaO, reactive MgO, or a combination thereof, total binder of concrete.

24. (canceled)

25. (canceled)

26. The process of claim 1, wherein the rate of microstructure development of the concrete mixture is such that the induction period of hydration is extended from 5 minutes to 10 hours.

27. The process claim 1, wherein the initial porosity of the concrete mixture ranges from about 1% to about 30% by volume.

28. (canceled)

29. (canceled)

30. The process of claim 1, wherein the concrete mixture comprises about 1% to about 50% by mass porous aggregates relative to the total amount of solid materials in the concrete mixture.

31. The process of claim 1, wherein the concrete mixture comprises about 0.01% to about 5% by mass porosity enhancing admixtures.

32.-57. (canceled)

58. The process of claim 1, wherein the CO₂-containing gas is an industrial CO₂-containing gas stream, dilute flue gas stream, a concentrated CO₂ gas stream, or biomass-derived CO₂.

59. The process claim 1, wherein the CO₂-containing gas is atmospherically derived CO₂ or direct air capture CO₂.

60.-93. (canceled)

94. The process of claim 1, wherein the concrete mixture comprises air-entraining admixtures selected from the group consisting of surfactants and foaming agents.

95. The process of claim 1, wherein the concrete mixture comprises LKD, cement, fly ash, and natural aggregates.

96.-107. (canceled)

108. A multistage process for making concrete, comprising:
providing a concrete mixture in a carbonation reactor;
contacting the mixture in a first stage with a composition comprising CO₂ and water; and
contacting the mixture in a second stage with a composition that has a higher volume percent CO₂ than in the first stage.

109. (canceled)

110. (canceled)

208. A concrete mixture, comprising:
up to 50% by mass reactive CaO, reactive MgO, or gypsum; and
at least one member selected from hydrated calcium carbonate, hydrated magnesium carbonate, or a combination thereof.

209.-271. (canceled)
